(19) United States
(12) Patent Application Publication
(10) Pub. No.: US 2023/0418003 A1
(43) Pub. Date: Dec. 28, 2023

(54) RECEIVER, RECEPTION DEVICE, COMMUNICATION DEVICE, AND COMMUNICATION SYSTEM

(71) Applicant: NEC Corporation, Tokyo (JP)

(72) Inventors: Koya Takata, Tokyo (JP); Hisashi Mizumoto, Tokyo (JP); Fujio Okumura, Kanagawa (JP)

(73) Assignee: NEC Corporation, Tokyo (JP)

(21) Appl. No.: 18/213,763

(22) Filed: Jun. 23, 2023

(30) Foreign Application Priority Data
Jun. 28, 2022 (JP) 2022-103137

(51) Int. Cl. G02B 6/42; H04B 10/40

(52) U.S. Cl. CPC G02B 6/4214; G02B 6/4246; H04B 10/40

(57) ABSTRACT

A receiver includes a ball lens, a light receiving element array including a plurality of light receiving elements arranged around the ball lens, and a light guide including a plurality of reflection units that guide optical signals concentrated by the ball lens toward the light receiving elements. Each of the reflection units includes a first reflector associated with one of the plurality of light receiving elements and having reflecting surfaces formed on inner side surfaces tapered from the ball lens toward the light receiving element, and a second reflector disposed inside the first reflector and formed by combining double-sided mirrors having reflecting surfaces parallel to the reflecting surfaces of the first reflector.

This application is based upon and claims the benefit of priority from Japanese Patent Application No. 2022-103137, filed on Jun. 28, 2022, the disclosure of which is incorporated herein in its entirety by reference.

### TECHNICAL FIELD

The present disclosure relates to a receiver or the like that receives an optical signal propagating in a space.

### BACKGROUND ART

In optical space communication, an optical signal propagating in a space is transmitted or received without using a medium such as an optical fiber (hereinafter also referred to as a spatial optical signal). In order to receive a spatial optical signal propagating in a wide space, it is preferable to use a lens having a diameter as large as possible. Furthermore, in the optical space communication, a light receiving element having a small capacitance is adopted in order to perform high-speed communication. Such a light receiving element has a light receiving portion of which an area is small. Since the focal length of the lens is limited, it is difficult to guide spatial optical signals arriving from various directions to the light receiving portion having a small area using a large-diameter lens.

Patent Literature 1 (JP S63-095407 A) discloses a light reception device including a spherical lens, an optical fiber bundle, and at least one light receiving element. The spherical lens concentrates light incident from a wide angle on one end face of the optical fiber bundle. The optical fiber bundle is a bundle structure in which a plurality of optical fibers are aggregated. The one end face of the optical fiber bundle is a planar-shaped light incident portion. The light incident portion is provided at a focal point distribution position of the spherical lens. The at least one light receiving element is provided on the other end face of the optical fiber bundle. The at least one light receiving element receives emitted light emitted from the other end face of the optical fiber bundle.

In the device of Patent Literature 1, light concentrated by the spherical lens is received by the optical fiber bundle including a plurality of optical fibers. The angle at which an individual optical fiber can concentrate light is very limited. Therefore, the incident surface of the individual optical fiber needs to be arranged substantially perpendicular to an outer peripheral surface of the spherical lens. As a result, in the device of Patent Literature 1, one end face side of the optical fiber bundle is larger than the diameter of the spherical lens, and light arriving at the spherical lens is blocked by the optical fiber bundle.

Although optical fibers are not used, for example, if the periphery of the ball lens is surrounded by a band-shaped sensor array including a plurality of light receiving elements, it is possible to receive optical signals arriving from an azimuth of 360 degrees. In order to receive light converged by the spherical lens, it is necessary to arrange many light receiving elements in a lattice pattern. The number of light receiving elements is limited by factors such as cost. Therefore, a proportion of a light receiving region of the light receiving element is small with respect to the spot of the concentrated light, and only a light receiving efficiency of about several percent can be obtained.

An object of the present disclosure is to provide a receiver and the like capable of efficiently receiving optical signals arriving from various directions.

### SUMMARY

According to an aspect of the present disclosure, a receiver includes a ball lens, a light receiving element array including a plurality of light receiving elements arranged around the ball lens, and a light guide including a plurality of reflection units that guide optical signals concentrated by the ball lens toward the light receiving elements. Each of the reflection units includes a first reflector associated with one of the plurality of light receiving elements and having reflecting surfaces formed on inner side surfaces tapered from the ball lens toward the light receiving element, and a second reflector disposed inside the first reflector and formed by combining double-sided mirrors having reflecting surfaces parallel to the reflecting surfaces of the first reflector.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a reception device according to a first example embodiment;

FIG. 2 is a conceptual diagram illustrating the example of the configuration of the reception device according to the first example embodiment;

FIG. 3 is a conceptual diagram for explaining an example in which a plurality of light receiving elements constituting a light receiving element array are arranged in the reception device according to the first example embodiment;

FIG. 4 is a conceptual diagram for explaining an example of a light guide of the reception device according to the first example embodiment;

FIG. 5 is a conceptual diagram for explaining an example of a reflection unit constituting the light guide of the reception device according to the first example embodiment;

FIG. 6 is a conceptual diagram for explaining an example of a configuration of a reception circuit included in the reception device according to the first example embodiment;

FIG. 7 is a conceptual diagram for explaining an example of a configuration of a reception control unit included in the reception circuit included in the reception device according to the first example embodiment;

FIG. 8 is a conceptual diagram for explaining a first example of the light guide according to the first example embodiment;

FIG. 9 is a conceptual diagram for explaining the first example of the light guide according to the first example embodiment;

FIG. 10 is a conceptual diagram for explaining the first example of the light guide according to the first example embodiment;

FIG. 11 is a conceptual diagram for explaining a second example of the light guide according to the first example embodiment;

FIG. 12 is a conceptual diagram for explaining a third example of the light guide according to the first example embodiment;

FIG. 13 is a conceptual diagram for explaining the third example of the light guide according to the first example embodiment;

FIG. 14 is a conceptual diagram for explaining the third example of the light guide according to the first example embodiment;

FIG. 15 is a conceptual diagram for explaining a fourth example of the light guide according to the first example embodiment;

FIG. 16 is a conceptual diagram for explaining the fourth example of the light guide according to the first example embodiment;

FIG. 17 is a conceptual diagram for explaining the fourth example of the light guide according to the first example embodiment;

FIG. 18 is a conceptual diagram for explaining an example in which light is concentrated by a ball lens of a reception device according to a related art;

FIG. 19 is a conceptual diagram for explaining an example in which optical signals concentrated by the ball lens are received in the reception device according to the related art;

FIG. 20 is a conceptual diagram illustrating an example in which optical signals are received by a reception device according to a related art;

FIG. 21 is a conceptual diagram illustrating an example in which optical signals are received by a reception device according to a related art;

FIG. 22 is a block diagram illustrating an example of a configuration of a communication device according to a second example embodiment;

FIG. 23 is a conceptual diagram illustrating an example of a configuration of a transmission device included in the communication device according to the second example embodiment;

FIG. 24 is a conceptual diagram illustrating an example of a configuration of the communication device according to the second example embodiment;

FIG. 25 is a conceptual diagram for explaining an application example of the communication device according to the second example embodiment;

FIG. 26 is a conceptual diagram illustrating an example of a configuration of a receiver according to a third example embodiment;

FIG. 27 is a conceptual diagram illustrating an example of a configuration of the receiver according to the third example embodiment; and

FIG. 28 is a block diagram illustrating an example of a hardware configuration for executing processing or control according to each of the example embodiments.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for describing the following example embodiments, a direction of an arrow in the drawings is exemplary, and does not limit a direction of light or a signal. In addition, a line indicating a trajectory of light in the drawings is conceptual, and does not accurately indicate an actual traveling direction or state of light. For example, in the drawings, a change in traveling direction or state of light caused by refraction, reflection, diffusion, or the like at an interface between air and a substance may be omitted, or a light flux may be expressed by a single line. In addition, hatching may not be applied to a cross section for the reason that an example of a light path is illustrated or a configuration is complicated.

### First Example Embodiment

First, a reception device according to the present example embodiment will be described with reference to the drawings. The reception device according to the present example embodiment is used for optical space communication in which an optical signal propagating in a space is transmitted or received without using a medium such as an optical fiber (hereinafter also referred to as a spatial optical signal). The reception device according to the present example embodiment may be used for applications other than optical space communication as long as the reception device is used to receive light propagating in a space. In the present example embodiment, unless otherwise specified, the spatial optical signal is regarded as parallel light because it arrives from a sufficiently distant position. Note that the drawings used in the description of the present example embodiment are conceptual and do not accurately depict an actual structure.

(Configuration)

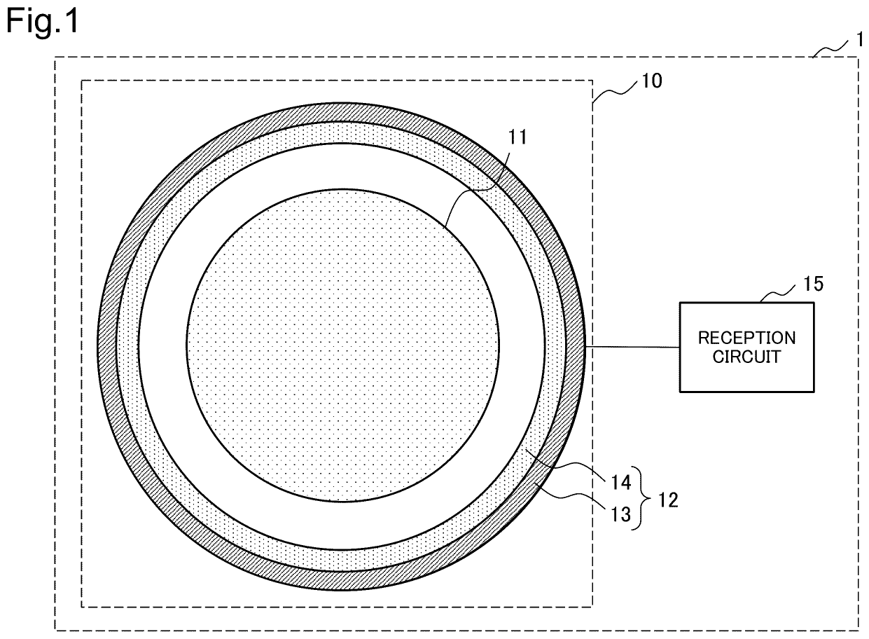

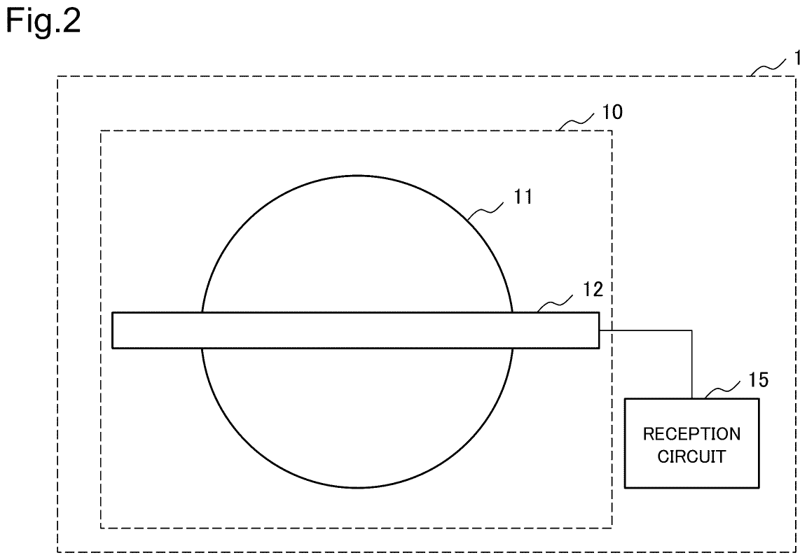

FIGS. 1 and 2 are conceptual diagrams illustrating an example of a configuration of a reception device 1 according to the present example embodiment. The reception device 1 includes a ball lens 11, a light receiving element array 13, a light guide 14, and a reception circuit 15. The ball lens 11, the light receiving element array 13, and the light guide 14 constitute a receiver 10. The light receiving element array 13 and the light guide 14 constitute a light receiving unit 12. FIG. 1 is a plan view of the receiver 10 of the reception device 1 as viewed from above. FIG. 2 is a side view of the receiver 10 of the reception device 1 as viewed in the lateral direction. A positional relationship between the ball lens 11, the light receiving element array 13, and the light guide 14 is fixed by supports (not illustrated). In the present example embodiment, the supports for fixing the positions of the light receiving element array 13 and the light guide 14 with respect to the ball lens 11 are omitted. Furthermore, the position of the reception circuit 15 is not particularly limited as long as it does not affect the reception of the spatial optical signal.

The ball lens 11 is a spherical lens. The ball lens 11 is an optical element that concentrates a spatial optical signal arriving from the outside. The ball lens 11 has a spherical shape when viewed at any angle. The ball lens 11 concentrates an incident spatial optical signal. Light (also referred to as an optical signal) derived from the spatial optical signal concentrated by the ball lens 11 is concentrated toward a concentrating region of the ball lens 11. Since the ball lens 11 has a spherical shape, the ball lens 11 concentrates a spatial optical signal arriving from any direction. That is, the ball lens 11 exhibits similar light concentrating performance for spatial optical signals arriving from any directions. The light incident on the ball lens 11 is refracted when entering the inside of the ball lens 11. Furthermore, the light traveling inside the ball lens 11 is refracted once more when emitted to the outside of the ball lens 11. Most of the light emitted from the ball lens 11 is concentrated in the concentrating region. On the other hand, the light incident from the periphery of the ball lens 11 is emitted in a direction away from the concentrating region when emitted from the ball lens 11.

For example, the ball lens 11 can be made of a material such as glass, crystal, or resin. In a case where a spatial optical signal in the visible region is received, the material such as glass, crystal, or resin capable of transmitting/refracting light in the visible region can be applied to the ball lens 11. For example, optical glass such as crown glass or flint glass can be applied to the ball lens 11. For example, crown glass such as BK (Boron Kron) can be applied to the ball lens 11. For example, flint glass such as Lanthanum Schwerflint (LaSF) can be applied to the ball lens 11. For example, quartz glass can be applied to the ball lens 11. For example, crystal such as sapphire can be applied to the ball lens 11. For example, transparent resin such as acryl can be applied to the ball lens 11.

In a case where the spatial optical signal is light in a near-infrared region (hereinafter also referred to as near-infrared light), a material capable of transmitting near-infrared light is used for the ball lens 11. For example, in a case where a spatial optical signal in a near-infrared region of about 1.5 micrometers (μm), a material such as silicon can be applied to the ball lens 11 in addition to glass, crystal, resin, or the like. In a case where the spatial optical signal is light in an infrared region (hereinafter also referred to as infrared light), a material capable of transmitting infrared light is used for the ball lens 11. For example, in a case where the spatial optical signal is infrared light, a silicon, germanium, or chalcogenide material can be applied to the ball lens 11. The material of the ball lens 11 is not limited as long as it is capable of transmitting/refracting light in the wavelength region of the spatial optical signal. The material of the ball lens 11 may be appropriately selected according to the desired refractive index and application.

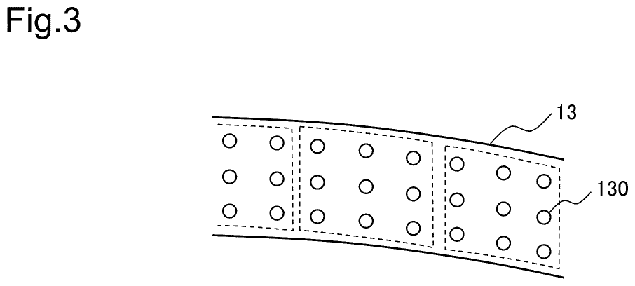

The light receiving element array 13 is disposed to surround the periphery of the ball lens 11. In the example of FIGS. 1 and 2, the light receiving element array 13 is provided in an annular shape. The light receiving element array 13 may be provided in a divided manner in an annular portion surrounding the periphery of the ball lens 11. The light receiving element array 13 includes a plurality of light receiving elements 130. FIG. 3 is a conceptual diagram illustrating an example in which the plurality of light receiving elements 130 are arranged. The plurality of light receiving elements 130 are arranged in a two-dimensional array in an annular plane. The plurality of light receiving elements 130 collectively receives optical signals derived from spatial optical signals arriving from the same direction in a light receiving group including several elements. In the example of FIG. 3, one light receiving group includes nine light receiving elements.

Each of the plurality of light receiving elements 130 includes a light receiving portion that receives an optical signal derived from a spatial optical signal to be received. A light receiving surface of each of the light receiving elements 130 includes a region where the light receiving portion is located (also referred to as a light receiving region) and a region where the light receiving portion is not located (also referred to as a non-sensing region). An optical signal that has reached the light receiving region is received by the light receiving portion of the light receiving element 130. An optical signal that has reached the non-sensing region is not received. In the present example embodiment, the optical signal concentrated by the ball lens 11 is guided to the light receiving portion of the light receiving element 130 using each of a plurality of light guide members constituting the light guide 14.

The light receiving portion of the light receiving element 130 faces the ball lens 11 with the light guide 14 interposed therebetween. The light guide member (which will be described below) constituting the light guide 14 is associated with each of the plurality of light receiving elements 130. An optical signal guided through the associated light guide member is incident on each of the plurality of light receiving elements 130. That is, the optical signal concentrated by the ball lens 11 is guided by the light guide 14 and received by the light receiving portion of the light receiving element 130. The light receiving element 130 converts the received optical signal into an electric signal. The light receiving element 130 outputs the converted electric signal to the reception circuit 15.

The light receiving element 130 receives light in a wavelength region of the spatial optical signal to be received. For example, the light receiving element 130 is sensitive to light in the visible region. For example, the light receiving element 130 is sensitive to light in the infrared region. The light receiving element 130 is sensitive to light having a wavelength, for example, in the 1.5 micrometers (μm) band. Note that the wavelength band of the light to which the light receiving element 130 is sensitive is not limited to the 1.5 μm band. The wavelength band of the light received by the light receiving element 130 can be set in accordance with a wavelength of a spatial optical signal transmitted from a transmission device (not illustrated). The wavelength band of the light received by the light receiving element 130 may be set to, for example, a 0.8 μm band, a 1.55 μm band, or a 2.2 μm band. Alternatively, the wavelength band of the light received by the light receiving element 130 may be, for example, a 0.8 to 1 μm band. The shorter the wavelength band, the smaller the absorption by moisture in the atmosphere, which is advantageous for optical spatial communication during rainfall. In addition, if saturated with intense sunlight, the light receiving element 130 is not capable of reading an optical signal derived from a spatial optical signal. Therefore, a color filter that selectively passes light in the wavelength band of the spatial optical signal may be installed in a stage before the light receiving element 130.

For example, the light receiving element 130 can be achieved by an element such as a photodiode or a phototransistor. For example, the light receiving element 130 is achieved by an avalanche photodiode. The light receiving element 130 achieved by the avalanche photodiode is capable of supporting high-speed communication. Note that the light receiving element 130 may be achieved by an element other than the photodiode, the phototransistor, or the avalanche photodiode as long as it is capable of converting an optical signal into an electric signal. In order to improve the communication speed, the light receiving portion of the light receiving element 130 is preferably as small as possible. For example, the light receiving portion of the light receiving element 130 has a square light receiving surface having a side of about 5 millimeters (mm). For example, the light receiving portion of the light receiving element 130 has a circular light receiving surface having a diameter of about 0.1 to 0.3 mm. The size and shape of the light receiving portion of the light receiving element 130 may be selected according to the wavelength band, the communication speed, and the like of the spatial optical signal.

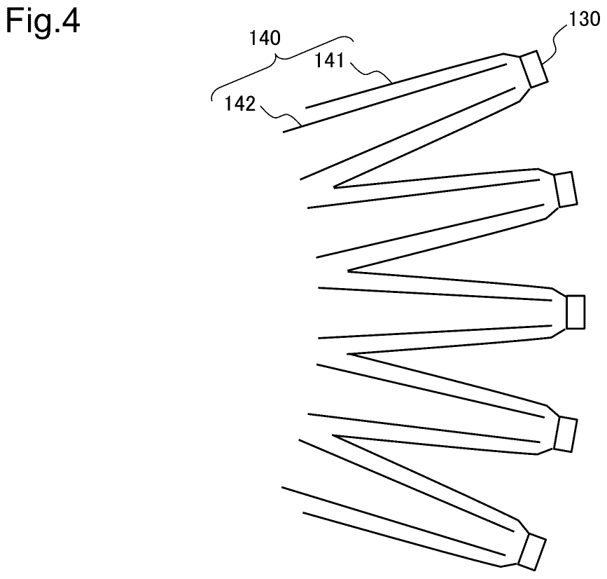

The light guide 14 is disposed in the concentrating region of the ball lens 11 to surround the periphery of the ball lens 11. FIG. 4 is a cross-sectional view of a partial portion of the light guide 14. The light guide 14 includes a plurality of reflection units 140. Each of the plurality of reflection units 140 is associated with one of the plurality of light receiving elements 130. The reflection unit 140 includes a first reflector 141 and a second reflector 142. The second reflector 142 is disposed inside the first reflector 141. An inner side surface of the first reflector 141 is a reflecting surface. Inner and outer side surfaces of the second reflector 142 are reflecting surfaces. The inner side surface (reflecting surface) of the first reflector 141 and the outer side surface (reflecting surface) of the second reflector 142 are disposed to face each other. The inner side surface (reflecting surface) of the first reflector 141 and the outer side surface (reflecting surface) of the second reflector 142 preferably include portions parallel to each other. Light having entered between the two reflecting surfaces having a parallel positional relationship travels while being multiply reflected by the two reflecting surfaces without returning to the entry direction. Therefore, when the reflecting surfaces of the second reflector 142 are entirely parallel to the inner reflecting surface of the first reflector 141, the light receiving efficiency of the light receiving element 130 is further improved. In addition, the first reflector 141 and the second reflector 142 may include curved reflecting surfaces. Even if the opposing reflecting surfaces of the first reflector 141 and the second reflector 142 are curved, if the reflecting surfaces are parallel to each other, light entering between the reflecting surfaces travels while being multiply reflected. The reflecting surfaces of the first reflector 141 and the second reflector 142 may include bent portions. In the example of FIG. 4, a partial portion of the second reflector 142 protrudes to the outside of the first reflector 141 on the side closer to the ball lens 11. The second reflector 142 may be disposed to be accommodated inside the first reflector 141. On the side closer to the light receiving element 130, an end portion of the second reflector 142 is separated from the light receiving element 130. The end portion of the second reflector 142 may contact the light receiving element 130.

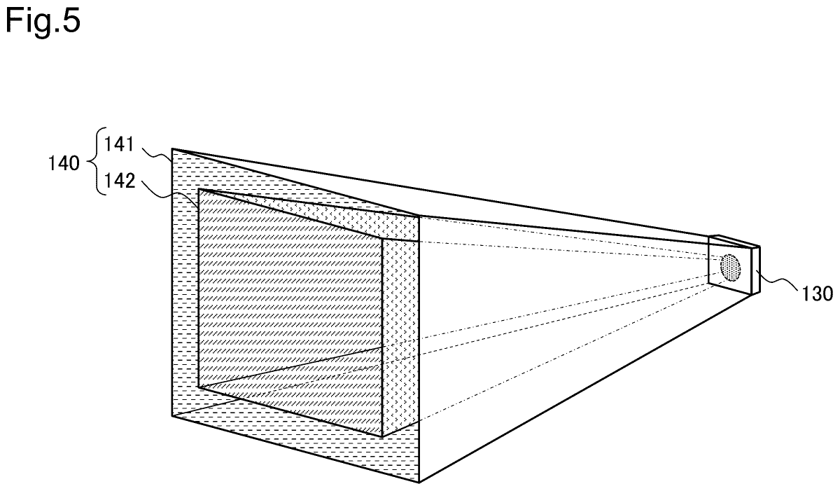

FIG. 5 is a perspective view of one reflection unit 140. The first reflector 141 has a configuration obtained by combining single-sided mirrors, each of which has a reflecting surface as one of side surfaces. The first reflector 141 has a structure in which a plurality of single-sided mirrors having trapezoidal side surfaces are combined together in a cylindrical shape with the reflecting surface of each of the mirrors facing inward. The second reflector 142 has a configuration obtained by combining double-sided mirrors, each of which has reflecting surfaces as opposite ones of side surfaces. The second reflector 142 has a structure in which a plurality of double-sided mirrors having trapezoidal side surfaces are combined together in a cylindrical shape with one of the reflecting surfaces of each of the mirrors facing inward. As illustrated in FIG. 5, the second reflector 142 is disposed inside the first reflector 141. A method for fixing the second reflector 142 inside the first reflector 141 is not particularly limited. The second reflector 142 can be fixed inside the first reflector 141, for example, by connecting four outer sides of the second reflector 142 and four inner sides of the first reflector 141 with columns or beams. Although it is exemplified in FIG. 5 that each of the first reflector 141 and the second reflector 142 has four surfaces, each of the first reflector 141 and the second reflector 142 may have five or more surfaces. For example, the surfaces of each of the first reflector 141 and the second reflector 142 may include curved surfaces.

Two openings having different opening areas are formed in the reflection unit 140 constituted by the first reflector 141 and the second reflector 142. One having a larger opening area (also referred to as a first opening surface) of the openings of the reflection unit 140 faces the ball lens 11. Some sides of the first opening surface are disposed to be close to the adjacent reflection units 140. It is preferable that the first opening surfaces of the adjacent reflection units 140 be disposed as tightly as possible. The light receiving element 130 is disposed on the other one having a smaller opening area (also referred to as a second opening surface) of the openings of the reflection unit 140. The second opening surface is disposed to be close to or connected to the light receiving portion of the light receiving element 130. For example, the second opening surface may be configured to have the same shape as the light receiving portion of the light receiving element 130. In that case, the first reflector 141 and the second reflector 142 may be formed to smoothly change from the shape of the first opening surface to the shape of the second opening surface.

The reception circuit 15 acquires a signal output from each of the plurality of light receiving elements 130. The reception circuit 15 amplifies the signal from each of the plurality of light receiving elements 130. The reception circuit 15 decodes the amplified signal and analyzes the signal from the communication target. For example, the reception circuit 15 is configured to collectively analyze signals of the plurality of light receiving elements 130 included in the same light receiving group. When the signals of the plurality of light receiving elements 130 are analyzed collectively, it is possible to achieve a single-channel reception device 1 that communicates with a single communication target. For example, the reception circuit 15 is configured to individually analyze a signal for each light receiving element 130. In a case where the signal is analyzed individually for each light receiving element 130, it is possible to achieve a multi-channel reception device 1 that communicates with a plurality of communication targets simultaneously. The signal decoded by the reception circuit 15 is used for any purpose. The use of the signal decoded by the reception circuit 15 is not particularly limited.

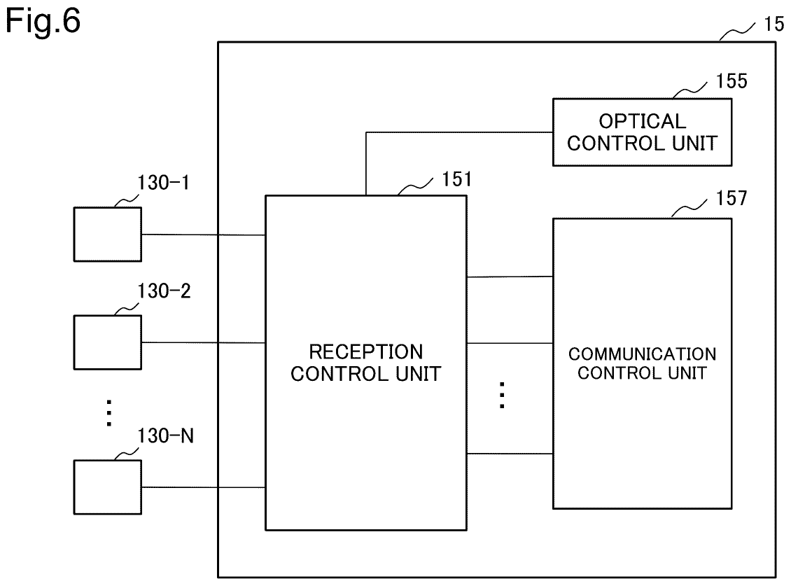

FIG. 6 is a block diagram illustrating an example of a configuration of the reception circuit 15. In the example of FIG. 6, the number of the plurality of light receiving elements 130 is N (N is a natural number). The reception circuit 15 includes a reception control unit 151, an optical control unit 155, and a communication control unit 157. FIG. 6 is an example of the configuration of the reception circuit 15, and does not limit the configuration of the reception circuit 15.

The plurality of light receiving elements 130-1 to 130-N is connected to the reception control unit 151. Signals output from the plurality of light receiving elements 130-1 to 130-N are input to the reception control unit 151. The reception control unit 151 amplifies the input signals. The reception control unit 151 outputs the amplified signals to the communication control unit 157.

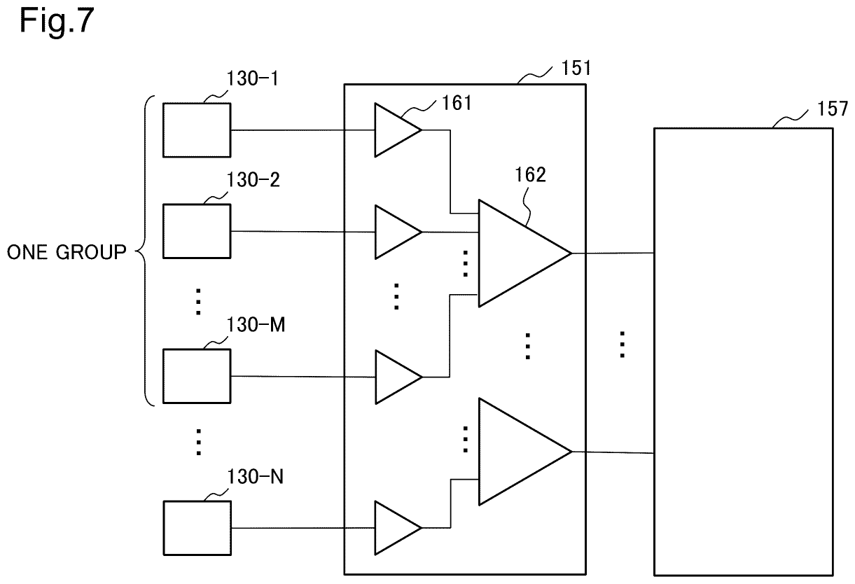

FIG. 7 is a conceptual diagram illustrating an example of a configuration of the reception control unit 151. In the example of FIG. 7, the reception control unit 151 includes a plurality of first amplifiers 161 and a plurality of second amplifiers 162. The first amplifier 161 is connected to one of the plurality of light receiving elements 130-1 to 130-N. The first amplifier 161 amplifies the input signal. The first amplifier 161 outputs the amplified signal to the second amplifier 162. The plurality of light receiving elements 130-1 to 130-N are allocated to one of the plurality of light receiving groups. In the example of FIG. 7, one light receiving group includes M light receiving elements 130 (M is a natural number smaller than N). Each of the plurality of second amplifiers 162 is allocated to one of the light receiving groups. Signals output from the plurality of first amplifiers 161 belonging to the allocated light receiving group are input to the second amplifier 162. The second amplifier 162 amplifies the input signals collectively for each light receiving group. The second amplifier 162 outputs the signals amplified for each light receiving group to the communication control unit 157. FIG. 7 illustrates an example of the configuration of the reception control unit 151, and does not limit the configuration of the reception control unit 151.

For example, the reception control unit 151 may be provided with a limiting amplifier (not illustrated) at a stage before the first amplifier 161. When the limiting amplifier is provided, a dynamic range can be secured. For example, the reception control unit 151 may be provided with a high-pass filter or a band-pass filter (not illustrated). The high-pass filter or the band-pass filter cuts a signal derived from ambient light such as sunlight, and selectively passes a high-frequency component signal corresponding to a wavelength band of a spatial optical signal. For example, the reception control unit 151 may be provided with a band-pass filter (not illustrated).

The optical control unit 155 is connected to the reception control unit 151. The optical control unit 155 acquires an output value of the signal amplified by the reception control unit 151. The optical control unit 155 monitors the output value of the signal.

The communication control unit 157 is connected to the reception control unit 151. The communication control unit 157 acquires the signal amplified by the reception control unit 151. That is, the communication control unit 157 acquires a signal derived from an optical signal received by each of the plurality of light receiving elements 130-1 to 130-N. The communication control unit 157 decodes the acquired signal. For example, the communication control unit 157 is configured to apply some signal processing to the decoded signal. For example, the communication control unit 157 is configured to output the decoded signal to an external signal processing device or the like (not illustrated).

[Light Guide]

Next, a configuration of the light guide 14 will be described with some examples. In the following description, similar components having different shapes will be denoted by the same reference sign. In addition, in the following description, a reference sign will be omitted for a similar component in one drawing.

### First Example

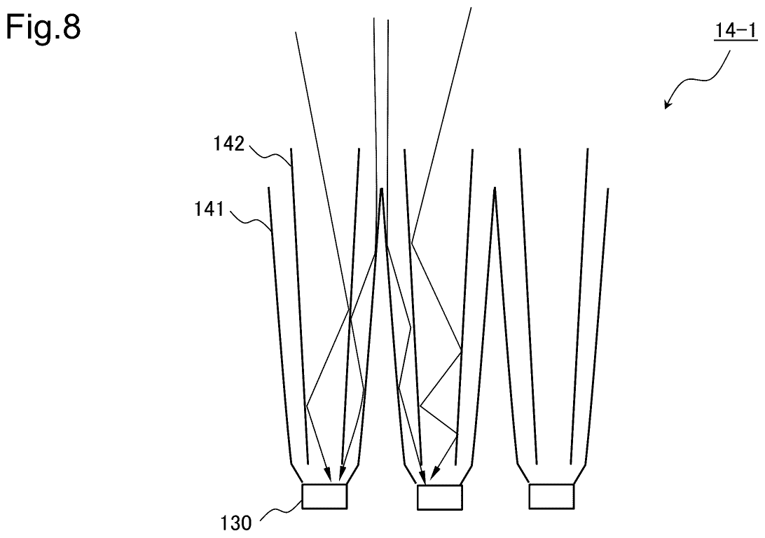

FIG. 8 is a conceptual diagram for explaining a first example (light guide 14-1) of the light guide 14 according to the present example embodiment. In the example of FIG. 8, adjacent reflection units are disposed in such a way that partial portions of first openings of first reflectors 141 are in contact with each other. Therefore, there is no gap between adjacent reflection units. A second opening surface of the reflection unit is open toward a light receiving portion of a light receiving element 130. In the example of FIG. 8, the first reflector 141 is bent around the second opening surface toward the light receiving portion of the light receiving element 130. A portion of the first reflector 141 around the second opening surface may have a planar shape or a curved shape.

In FIG. 8, the state of light incident on the reflection unit is indicated by lines including arrowheads. The light incident between the first reflector 141 and the second reflector 142 reaches the light receiving portion of the light receiving element 130, while being multiply reflected by a reflecting surface of the first reflector 141 and a reflecting surface of the second reflector 142. The light incident on the second reflector 142 reaches the light receiving portion of the light receiving element 130, while being multiply reflected by reflecting surfaces of the second reflector 142. In a case where the light receiving elements 130 belong to the same light receiving group, optical signals received by the adjacent light receiving elements 130 as illustrated in FIG. 8 can be integrated as what are derived from a spatial optical signal transmitted from the same communication target. In a case where the light receiving elements 130 belong to different light receiving groups, optical signals received by the adjacent light receiving elements 130 as illustrated in FIG. 8 can be separately received as what are derived from spatial optical signals transmitted from different communication targets.

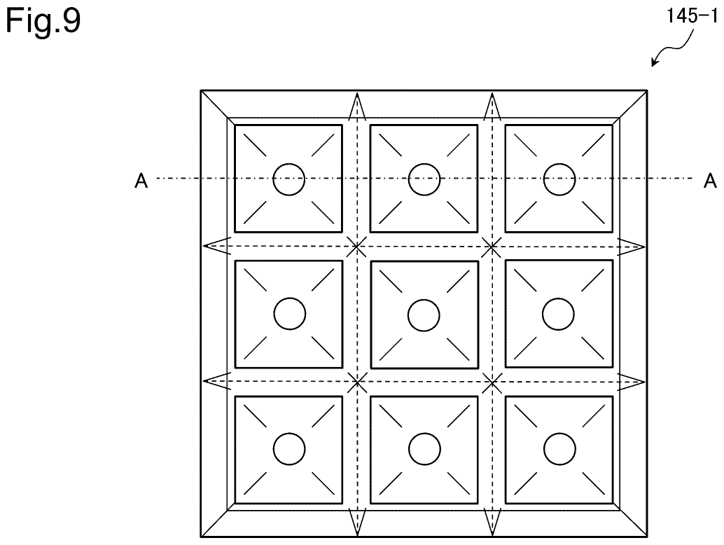

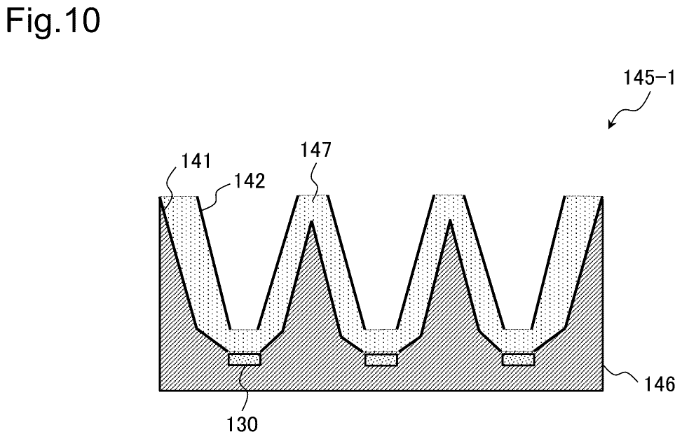

FIGS. 9 and 10 are conceptual diagrams illustrating an example of a light guide 145-1 associated with a light receiving group including nine light receiving elements 130 arranged in an array of 3 rows×3 columns. FIG. 9 is a plan view of the light guide 145-1 as viewed from above. FIG. 10 is a cross-sectional view of the light guide 145-1 taken along line A-A in FIG. 9.

The light guide 145-1 is disposed on one surface (front surface) of a substrate 146 processed to match the shape of the reflecting surface of the first reflector 141 and the shape of the light receiving element 130. The light receiving element 130 may be disposed on an external side (back surface) of the substrate 146. The first reflector 141 and the second reflector 142 can be formed by forming reflecting surfaces on both surfaces of a transparent member 147. The reflecting surface of the first reflector 141 may be formed on an inclined surface on the front surface side of the substrate 146. In order to increase an input of an optical signal to the reflection unit, the opening (first opening) on the incident side of the reflection unit has a square shape (square). The opening (second opening) on the emission side of the reflection unit is circular to match the shape of the light receiving portion of the light receiving element 130. A parallel positional relationship between the reflecting surface of the first reflector 141 and the external reflecting surface of the second reflector 142 is maintained by the transparent member 147.

For example, the transparent member 147 processed to match the shape of the front surface of the substrate 146 is attached to the front surface of the substrate 146. The transparent member 147 may be formed on the front surface of the substrate 146 using a technique such as injection molding. The transparent member is made of a material such as resin or glass capable of transmitting an optical signal to be communicated. For example, when the wavelength band of the spatial optical signal is a 1.55 micrometer (μm) band, the transparent member is made of a material that is capable of easily transmitting light of that wavelength band. In terms of processability, the transparent member is preferably acrylic resin. In terms of light transmissivity, the transparent member is preferably quartz glass or the like.

In the example of FIGS. 9 and 10, light incident between the first reflector 141 and the second reflector 142 is received by the light receiving portion of the light receiving element 130, after traveling inside the transparent member 147 while being multiply reflected by the reflecting surface of the first reflector 141 and the reflecting surface of the second reflector 142. Also, light incident inside the second reflector 142 is received by the light receiving portion of the light receiving element 130, after traveling toward the light receiving element 130 while being multiply reflected by the reflecting surfaces of the second reflector 142.

### Second Example

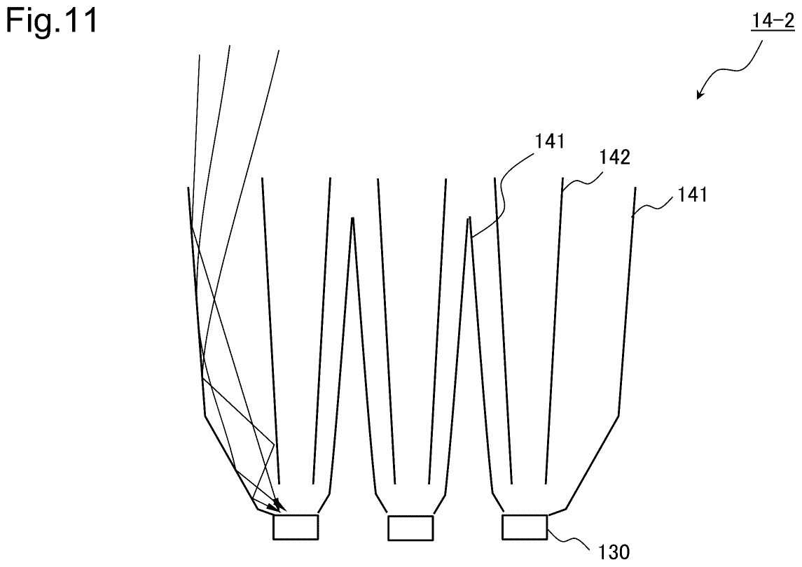

FIG. 11 is a conceptual diagram for explaining a second example (light guide 14-2) of the light guide 14 according to the present example embodiment. In the example of FIG. 11, similarly to the first example (FIG. 8), adjacent reflection units are disposed in such a way that partial portions of first openings of first reflectors 141 are in contact with each other. Therefore, there is no gap between adjacent reflection units. In the example of FIG. 11, reflecting surfaces of the first reflectors 141 extend outward in the outer peripheral portions of the plurality of reflection units disposed at the outward positions. A second opening surface of the reflection unit is open toward a light receiving portion of a light receiving element 130.

In FIG. 11, the state of light incident on the reflection unit is indicated by lines including arrowheads. The light incident between the first reflector 141 and the second reflector 142 reaches the light receiving portion of the light receiving element 130, while being reflected by a reflecting surface of the first reflector 141 and a reflecting surface of the second reflector 142. The light incident inside the second reflector 142 reaches the light receiving portion of the light receiving element 130, while being reflected by reflecting surfaces of the second reflector 142. In the structure of the light guide 14-2 in FIG. 11, the first reflector 141 extends outward at the outer peripheral portion. Therefore, it is possible to expand the range in which optical signals are received as compared with that in the first example (FIG. 8).

### Third Example

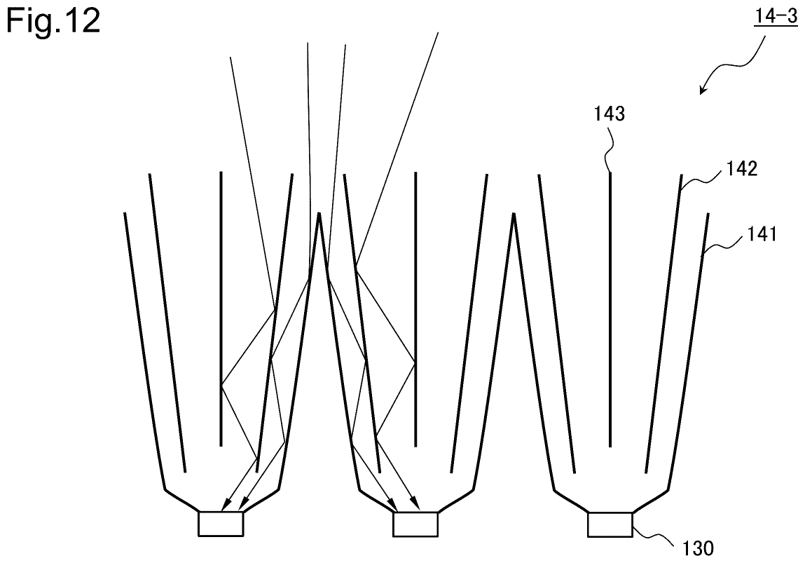

FIG. 12 is a conceptual diagram for explaining a third example (light guide 14-3) of the light guide 14 according to the present example embodiment. The light guide 14-3 includes a third reflector 143 in addition to the first reflector 141 and the second reflector 142.

The third reflector 143 is a plane mirror having reflecting surfaces on both sides. The third reflector 143 is disposed inside the second reflector 142. The third reflector 143 is disposed perpendicular to a light receiving surface of a light receiving element 130. In the example of FIG. 12, adjacent reflection units are disposed in such a way that partial portions of first openings of first reflectors 141 are in contact with each other. Therefore, there is no gap between adjacent reflection units. A second opening surface of the reflection unit is open toward a light receiving portion of a light receiving element 130. In the example of FIG. 12, the first reflector 141 is bent around the second opening surface toward the light receiving portion of the light receiving element 130. A portion of the first reflector 141 around the second opening surface may have a planar shape or a curved shape.

In FIG. 12, the state of light incident on the reflection unit is indicated by lines including arrowheads. The light incident between the first reflector 141 and the second reflector 142 reaches the light receiving portion of the light receiving element 130, while being multiply reflected by a reflecting surface of the first reflector 141 and a reflecting surface of the second reflector 142. The light incident between the second reflector 142 and the third reflector 143 reaches the light receiving portion of the light receiving element 130, while being multiply reflected by a reflecting surface of the second reflector 142 and a reflecting surface of the third reflector 143.

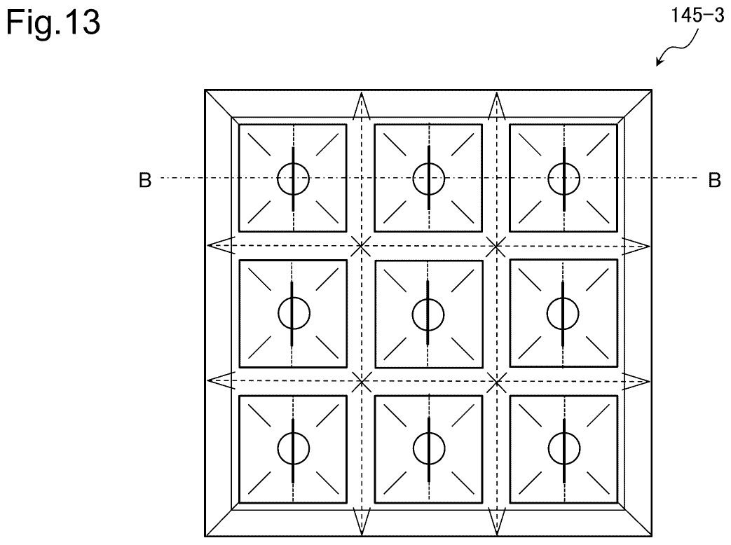

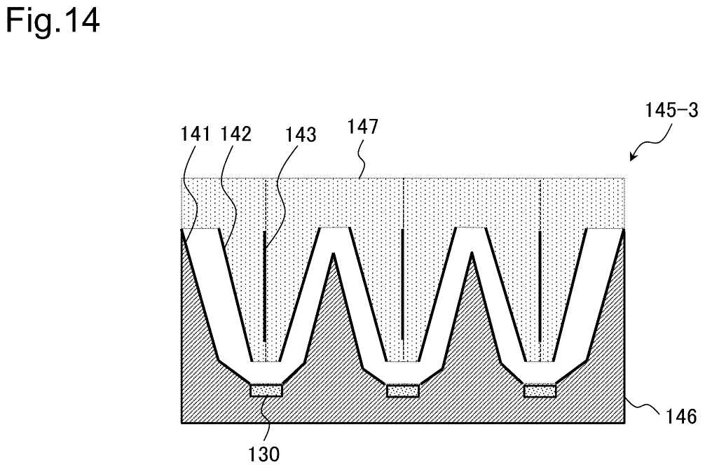

FIGS. 13 and 14 are conceptual diagrams illustrating an example of a light guide 145-3 associated with a light receiving group including nine light receiving elements 130 arranged in an array of 3 rows×3 columns. FIG. 13 is a plan view of the light guide 145-3 as viewed from above. FIG. 14 is a cross-sectional view of the light guide 145-3 taken along line B-B in FIG. 13. The reflecting surface of the first reflector 141 is formed on an inclined surface on the front surface side of the substrate 146. The light receiving element 130 may be disposed on an external side (back surface) of the substrate 146. For example, a transparent member 147 where a reflecting surface of the second reflector 142 is formed on an inclined surface on the lower side and a reflecting surface of the third reflector 143 is formed on a vertical surface (side surface) is disposed on a front surface of the substrate 146. In the example of FIGS. 13 and 14, broken lines indicate a state in which a plurality of transparent members 147 on which the reflecting surfaces of the second reflector 142 and the third reflector 143 are formed are combined. The material of the transparent member 147 is the same as that in the first example.

In the example of FIGS. 13 and 14, the light incident between the reflecting surface of the first reflector 141 and the reflecting surface of the second reflector 142 is received by the light receiving portion of the light receiving element 130 while being reflected by the reflecting surface of the first reflector 141 and the reflecting surface of the second reflector 142. The light incident between the second reflector 142 and the third reflector 143 is received by the light receiving portion of the light receiving element 130, after traveling inside the transparent member 147 while being reflected by the reflecting surface of the second reflector 142 and the reflecting surface of the third reflector 143. In the third example, by interposing the third reflector 143 inside the second reflector 142, even if the opening on the incident side of the second reflector 142 is widened, the amount of light returning to the incident side is reduced. Therefore, it is possible to arrange the light receiving elements 130 at a wider distance therebetween in the third example as compared with those in the first example. That is, according to the third example, the number of light receiving elements 130 constituting the light receiving element array 13 can be reduced.

### Fourth Example

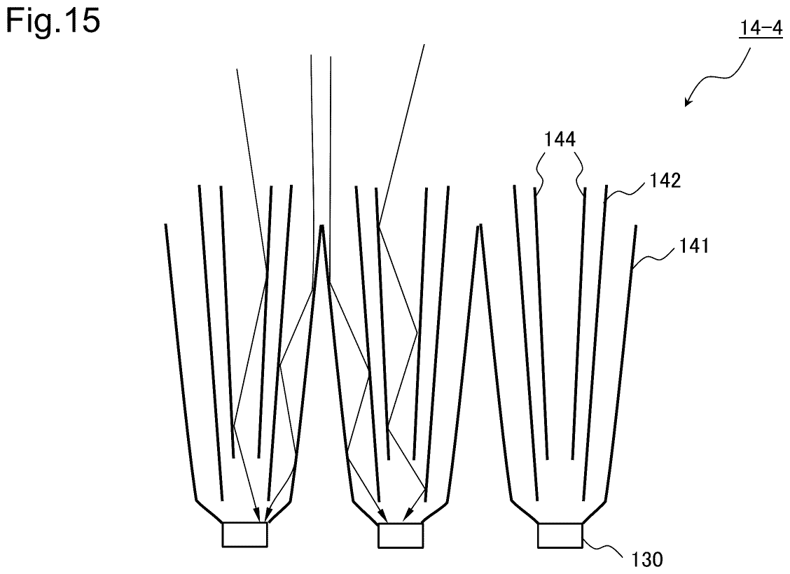

FIG. 15 is a conceptual diagram for explaining a fourth example (light guide 14-4) of the light guide 14 according to the present example embodiment. The light guide 14-4 includes a fourth reflector 144 in addition to the first reflector 141 and the second reflector 142. The fourth reflector 144 has a configuration in which the second reflector 142 is downsized.

The fourth reflector 144 has a structure in which a plurality of double-sided mirrors having trapezoidal side surfaces are combined together in a cylindrical shape with one of the reflecting surfaces of each of the mirrors facing inward. As illustrated in FIG. 15, the fourth reflector 144 is disposed inside the second reflector 142. A method for fixing the fourth reflector 144 inside the second reflector 142 is not particularly limited. The fourth reflector 144 can be fixed inside the second reflector 142, for example, by connecting four outer sides of the fourth reflector 144 and four inner sides of the second reflector 142 with columns or beams. In the fourth example, it is assumed that each of the first reflector 141, the second reflector 142, and the fourth reflector 144 includes four surfaces. Each of the first reflector 141, the second reflector 142, and the fourth reflector 144 may include five or more surfaces. For example, the surface of each of the first reflector 141, the second reflector 142, and the fourth reflector 144 may include a curved surface.

In the example of FIG. 15, adjacent reflection units are disposed in such a way that partial portions of first openings of first reflectors 141 are in contact with each other. Therefore, there is no gap between adjacent reflection units. A second opening surface of the reflection unit is open toward a light receiving portion of a light receiving element 130. In the example of FIG. 15, the first reflector 141 is bent around the second opening surface toward the light receiving portion of the light receiving element 130. A portion of the first reflector 141 around the second opening surface may have a planar shape or a curved shape.

In FIG. 15, the state of light incident on the reflection unit is indicated by lines including arrowheads. The light incident between the first reflector 141 and the second reflector 142 reaches the light receiving portion of the light receiving element 130, while being multiply reflected by a reflecting surface of the first reflector 141 and a reflecting surface of the second reflector 142. The light incident between the second reflector 142 and the fourth reflector 144 reaches the light receiving portion of the light receiving element 130, while being multiply reflected by a reflecting surface of the second reflector 142 and a reflecting surface of the fourth reflector 144.

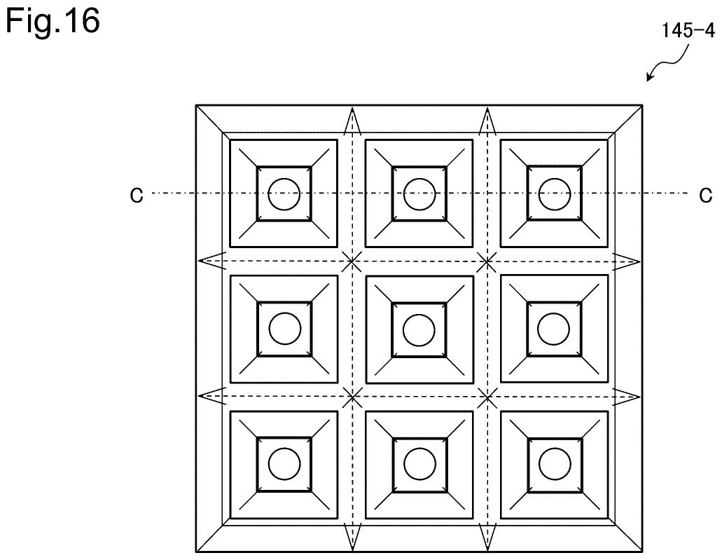

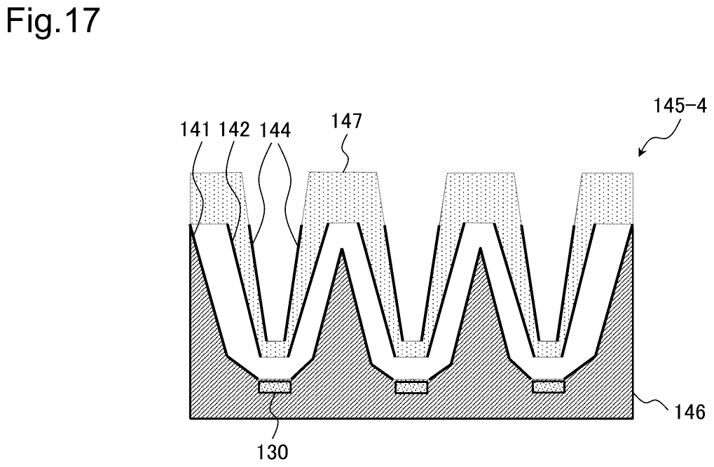

FIGS. 16 and 17 are conceptual diagrams illustrating an example of a light guide 145-4 associated with a light receiving group including nine light receiving elements 130 arranged in an array of 3 rows×3 columns. FIG. 16 is a plan view of the light guide 145-4 as viewed from above. FIG. 17 is a cross-sectional view of the light guide 145-4 taken along line C-C in FIG. 16.

The light guide 145-4 is formed on a front surface of a substrate 146 processed to match the shape of the reflecting surface of the first reflector 141 and the shape of the light receiving element 130. The light receiving element 130 may be disposed on an external side (back surface) of the substrate 146. The reflecting surface of the first reflector 141 is formed on an inclined surface on the front surface side of the substrate 146. For example, the transparent member 147 is attached to the front surface of the substrate 146. A reflecting surface of the second reflector 142 is formed on an inclined surface (lower surface) on the convex side of the transparent member 147. A reflecting surface of the fourth reflector 144 is formed on an inclined surface (upper surface) on the concave side of the transparent member 147. The material of the transparent member 147 is the same as that in the first example. An inner reflecting surface of the fourth reflector 144 may also be filled with the transparent member 147.

In the example of FIGS. 16 and 17, the light incident between the reflecting surface of the first reflector 141 and the reflecting surface of the second reflector 142 is received by the light receiving portion of the light receiving element 130 while being multiply reflected by the reflecting surface of the first reflector 141 and the reflecting surface of the second reflector 142. The light incident between the reflecting surface of the second reflector 142 and the reflecting surface of the fourth reflector 144 is received by the light receiving portion of the light receiving element 130, after traveling inside the transparent member 147 while being multiply reflected by the second reflector 142 and the fourth reflector 144. Also, light incident inside the fourth reflector 144 is received by the light receiving portion of the light receiving element 130, after traveling toward the light receiving element 130 while being multiply reflected by the reflecting surfaces of the fourth reflector 144.

### Related Art

Next, related arts relevant to the present example embodiment will be described with reference to the drawings. Examples of the related art include an example in which the light guide 14 is not included and an example in which the light guide 14 is different.

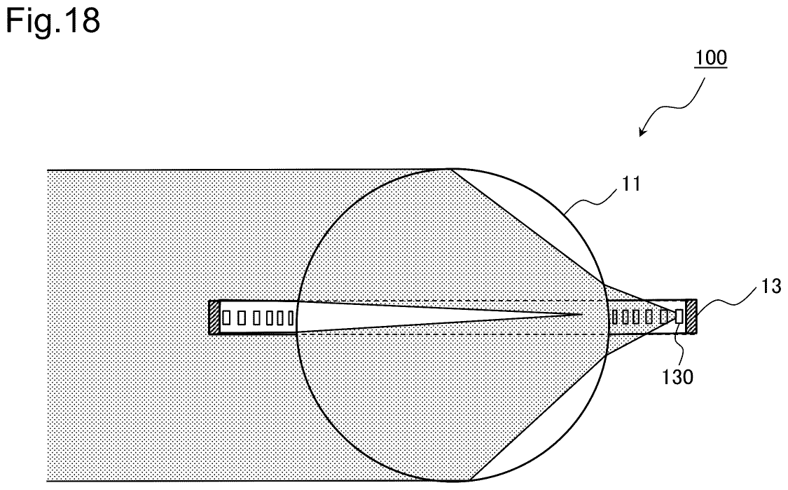

FIG. 18 is a conceptual diagram illustrating an example of a configuration of a receiver 100 according to a first related art. The receiver 100 includes a ball lens 11 and a light receiving element array 13 similar to those in the first example embodiment.

However, the receiver 100 does not include a light guide 14. The light receiving element array 13 has a structure in which the plurality of light receiving elements 130 are arranged in an annular shape. In FIG. 18, the annular-shaped light receiving element array 13 is divided into halves, and a state in which an optical signal is concentrated by the ball lens 11 is illustrated by hatching. According to the configuration of FIG. 18, by using the spherical ball lens 11, a spatial optical signal arriving from an azimuth of 360 degrees in a plane having a shallow angle with respect to the horizontal plane is received.

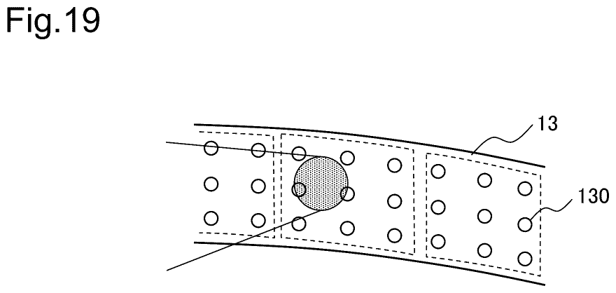

FIG. 19 illustrates a state in which the optical signal concentrated by the ball lens 11 is concentrated on the light receiving element array 13 in the configuration according to the first related art of FIG. 18. In FIG. 19, a light receiving group includes nine light receiving elements 130 arranged in an array of 3 rows×3 columns. In FIG. 19, a plurality of light receiving elements 130 of the same light receiving group are surrounded by a broken line. The optical signal is concentrated into a light receiving region including a light receiving portion of the light receiving element 130 and a non-sensing region. The optical signal concentrated in the light receiving region is received by a reception circuit (not illustrated). The optical signal concentrated in the non-sensing region is not received by the reception circuit (not illustrated). In order to perform high-speed communication, a light receiving element having a small capacitance is adopted. Such a light receiving element has a light receiving portion of which an area is small. In the configuration in which there is no light guide 14, a light reception loss occurs as much as the amount of the optical signal concentrated in the non-sensing region. In the configuration according to the present example embodiment, an optical signal is guided toward the light receiving portion of the light receiving element 130 by the light guide 14. Therefore, efficiency can be improved in receiving light of the optical signal in the configuration according to the present example embodiment, when compared with that in the first related art of FIGS. 18 and 19.

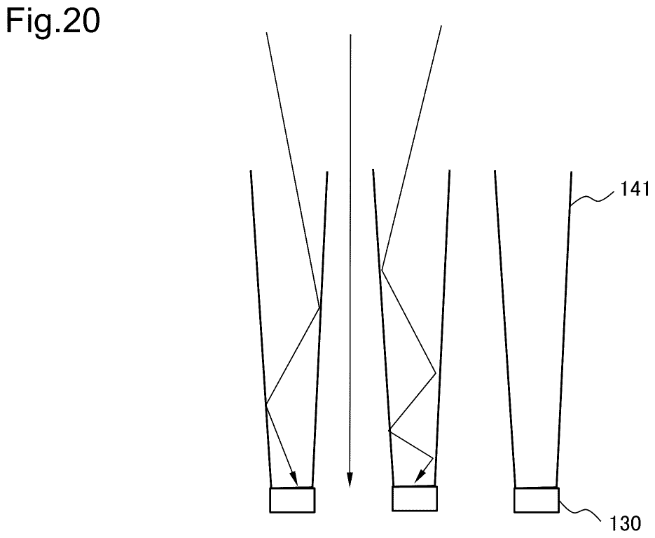

FIG. 20 is a conceptual diagram related to a second related art in which a light guide including only first reflectors 141 is used. In the example of FIG. 20, an inclination angle inside the first reflector 141 is formed to be small in such a way that an optical signal entering the inside of the first reflector 141 hardly returns to the incident surface. In the example of FIG. 20, a gap between adjacent first reflectors 141 is formed according to an interval between a plurality of light receiving elements 130 constituting a light receiving element array 13. An optical signal that has entered the gap between the adjacent first reflectors 141 is not received by the light receiving elements 130. Therefore, in the configuration of FIG. 20, a light reception loss occurs as much as the amount of the optical signal entering the gap between the adjacent first reflectors 141.

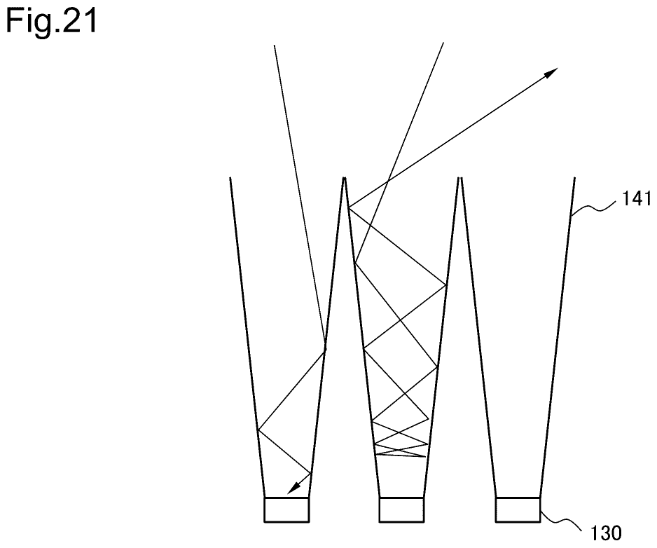

FIG. 21 is a conceptual diagram related to a third related art in which a light guide including only first reflectors 141 is used. In the example of FIG. 21, an inclination angle inside the first reflector 141 is formed to be larger than that in FIG. 20. In the example of FIG. 21, the number of light receiving elements 130 constituting a light receiving element array 13 is the same as that in the example of FIG. 20. The first reflectors 141 are disposed in such a manner that there is no gap between the adjacent first reflectors 141. Therefore, an optical signal does not enter the gap between the adjacent first reflectors 141. However, in the example of FIG. 21, when an incident angle of an optical signal onto a reflecting surface of the first reflector 141 is large, there is a possibility that the optical signal having entered the first reflector 141 returns to the incident side through multiple times of reflection. That is, when the inclination angle inside the first reflector 141 is too large, light returning due to multiple times of reflection increases. If the first reflectors 141 each having a small inclination angle inside the first reflector 141 are disposed to have no gap therebetween as illustrated in FIG. 20, a light reception loss caused by an optical signal entering a gap between adjacent first reflectors 141 and returning light is eliminated. In that case, it is necessary to reduce the interval between the light receiving elements 130 constituting the light receiving element array 13, and accordingly, it is necessary to increase the number of light receiving elements 130 constituting the light receiving element array 13. The increase in the number of light receiving elements 130 leads to an increase in cost.

In the configuration of the present example embodiment, the reflection unit 140 in which the first reflector 141 and the second reflector 142 are combined is used. Therefore, in the configuration of the present example embodiment, since there is no gap between adjacent reflection units, a light reception loss caused by an optical signal entering the gap as illustrated in FIG. 20 can be eliminated. In addition, it is possible to reduce the number of optical signals returning to the incident side by using the first reflectors 141 each having a large inclination angle inside similarly to those in FIG. 21. That is, according to the configuration of the present example embodiment, it is possible to eliminate a light reception loss caused by an optical signal entering a gap between adjacent first reflectors 141 and light returning due to multiple times of reflection.

As described above, the reception device according to the present example embodiment includes a ball lens, a light receiving element array, a light guide, and a reception circuit. The ball lens, the light guide, and the light receiving element array constitute a receiver. The light guide and the light receiving element array constitute a light receiving unit. The ball lens is a spherical lens. The light receiving element array includes a plurality of light receiving elements arranged around the ball lens. The light guide includes a plurality of reflection units that guide optical signals concentrated by the ball lens toward the light receiving elements. The reflection unit includes a first reflector and a second reflector. The first reflector is associated with one of the plurality of light receiving elements. The first reflector has a configuration in which reflecting surfaces are formed on inner surfaces tapered from the ball lens toward the light receiving element. The second reflector is disposed inside the first reflector. The second reflector has a configuration in which double-sided mirrors having reflecting surfaces parallel to the reflecting surfaces of the first reflector are combined together. The reception circuit acquires the signal received by the receiver. The reception circuit decodes the acquired signal.

The reception device according to the present example embodiment concentrates optical signals arriving from various directions using the ball lens. The optical signal concentrated by the ball lens enters one of the plurality of reflection units constituting the light guide. Among the optical signals that have entered the reflection unit, an optical signal that has entered between the first reflector and the second reflector is received by the light receiving element while being multiply reflected between the reflecting surface of the first reflector and the reflecting surface of the second reflector. Among the optical signals that have entered the reflection unit, an optical signal that has entered in the second reflector is received by the light receiving element while being multiply reflected between the reflecting surfaces of the second reflector. That is, the optical signals concentrated by the ball lens are efficiently guided by one of the plurality of reflection units constituting the light guide toward the light receiving element associated with the reflection unit. The optical signal received by the light receiving element is converted into an electric signal, and the electric signal is received by the reception circuit. Therefore, the reception device according to the present example embodiment can efficiently receive optical signals arriving from various directions.

In an aspect of the present example embodiment, the first reflector includes four reflecting surfaces tapered from the ball lens toward the light receiving element. The second reflector has a configuration in which four double-sided mirrors each disposed in association with one of the four reflecting surfaces included in the first reflector are combined. In the present aspect, the light receiving element receives optical signals multiply reflected between the reflecting surface of the first reflector and the reflecting surface of the second reflector and between the reflecting surfaces of the second reflector. According to the present aspect, by using the reflection unit including the first reflector and the second reflector having the reflecting surfaces facing each other, it is possible to efficiently receive optical signals arriving from various directions.

The receiver according to an aspect of the present example embodiment includes a third reflector. The third reflector is disposed inside the second reflector. The third reflector includes a double-sided mirror having reflecting surfaces parallel to a straight line connecting the center of the ball lens and the light receiving element to each other. In the present aspect, the light receiving element receives optical signals multiply reflected between the reflecting surface of the first reflector and the reflecting surface of the second reflector and between the reflecting surface of the second reflector and the reflecting surface of the third reflector. According to the present aspect, by using the reflection unit including the third reflector, light having a large incident angle with respect to the reflecting surface can be guided toward the light receiving element without returning the light in a direction toward the ball lens. Therefore, according to the present aspect, it is possible to increase inclination angles of inner side surfaces of the first reflector and the second reflector, and accordingly, it is possible to increase an interval between the plurality of light receiving elements. As a result, according to the present aspect, the number of light receiving elements constituting the light receiving element array can be reduced.

The receiver according to an aspect of the present example embodiment includes a fourth reflector. The fourth reflector is disposed inside the second reflector. The fourth reflector has a configuration in which double-sided mirrors having reflecting surfaces parallel to the reflecting surfaces of the second reflector are combined together. In the present aspect, the light receiving element receives optical signals multiply reflected between the reflecting surface of the first reflector and the reflecting surface of the second reflector, between the reflecting surface of the second reflector and the reflecting surface of the fourth reflector, and between the reflecting surfaces of the fourth reflector. According to the present aspect, by using the reflection unit including the fourth reflector, light having a large incident angle with respect to the reflecting surface can be guided toward the light receiving element without returning the light in a direction toward the ball lens. Therefore, according to the present aspect, it is possible to increase inclination angles of inner side surfaces of the first reflector and the second reflector, and accordingly, it is possible to increase an interval between the plurality of light receiving elements. As a result, according to the present aspect, the number of light receiving elements constituting the light receiving element array can be reduced.

In an aspect of the present example embodiment, each of the reflecting surfaces of the first reflector has a portion bent toward the light receiving portion of the light receiving element around the light receiving element. According to the present aspect, it is possible to increase an inclination angle of most of each of the inner side surfaces of the first reflector and the second reflector, and accordingly, it is possible to increase an interval between the plurality of light receiving elements. Therefore, according to the present aspect, the number of light receiving elements constituting the light receiving element array can be reduced.

In an aspect of the present example embodiment, the plurality of reflection units are grouped according to a direction from which the spatial optical signals arrive. For example, the light guide has a structure in which the plurality of grouped reflection units are integrated. According to the present aspect, the receiver can be easily manufactured by integrally molding the plurality of reflection units.

### Second Example Embodiment

Next, a communication device according to a second example embodiment will be described with reference to the drawings. The communication device according to the present example embodiment has a configuration in which a reception device and a transmission device are combined. The reception device has the configuration according to the first example embodiment. The transmission device transmits a spatial optical signal. Hereinafter, a communication device including a transmission device including a phase modulation-type spatial light modulator will be exemplified. Note that the communication device according to the present example embodiment may include a transmission device having a light transmission function rather than the phase modulation-type spatial light modulator.

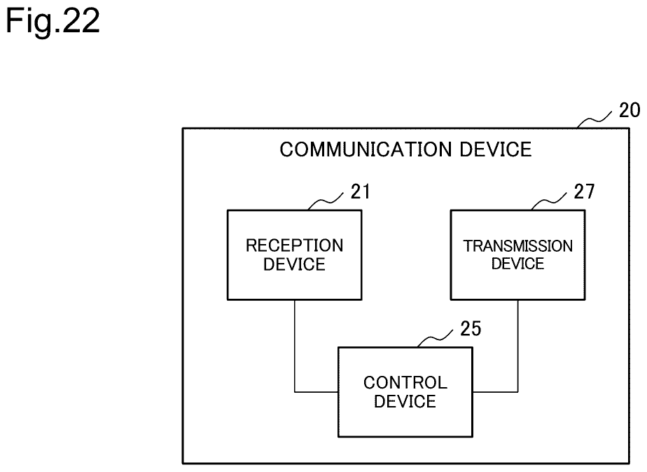

FIG. 22 is a conceptual diagram illustrating an example of a configuration of a communication device 20 according to the present example embodiment. The communication device 20 includes a reception device 21, a control device 25, and a transmission device 27. The communication device 20 transmits and receives spatial optical signals to and from an external communication target. Therefore, an opening or a window for transmitting and receiving a spatial optical signal is formed in the communication device 20.

The reception device 21 is the reception device according to the first example embodiment. The reception device 21 receives a spatial optical signal transmitted from a communication target (not illustrated). The reception device 21 converts the received spatial optical signal into an electrical signal. The reception device 21 outputs the converted electric signal to the control device 25.

The control device 25 acquires the signal output from the reception device 21. The control device 25 executes processing according to the acquired signal. The processing executed by the control device 25 is not particularly limited. The control device 25 outputs a control signal for transmitting an optical signal corresponding to the executed processing to the transmission device 27. For example, the control device 25 executes processing based on a predetermined condition according to information included in the signal received by the reception device 21. For example, the control device 25 executes processing designated by an administrator of the communication device 20 according to information included in the signal received by the reception device 21.

The transmission device 27 acquires a control signal from the control device 25. The transmission device 27 projects a spatial optical signal corresponding to the control signal. The spatial optical signal projected from the transmission device 27 is received by a communication target (not illustrated) to which the spatial optical signal is transmitted. For example, the transmission device 27 includes a phase modulation-type spatial light modulator. Alternatively, the transmission device 27 may have a light transmission function rather than the phase modulation-type spatial light modulator.

[Transmission Device]

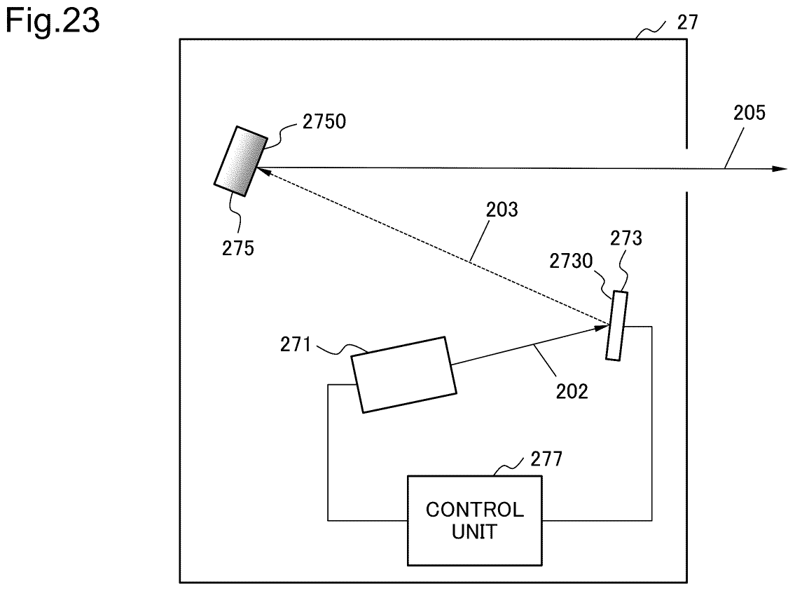

FIG. 23 is a conceptual diagram illustrating an example of a configuration of the transmission device 27. The transmission device 27 includes a light source 271, a spatial light modulator 273, a curved mirror 275, and a control unit 277. FIG. 23 is a side view of an internal configuration of the transmission device 27 as viewed in the lateral direction. FIG. 23 is conceptual, and does not accurately indicate a positional relationship between the components, a traveling direction of light, etc.

The light source 271 emits laser light in a predetermined wavelength band according to the control of the control unit 277. The wavelength of the laser light emitted from the light source 271 is not particularly limited, and may be selected according to the application. For example, the light source 271 emits laser light in the visible or infrared wavelength band. For example, near-infrared light of 800 to 900 nanometers (nm) can raise the laser class, thereby improving sensitivity by about 1 digit as compared with the other wavelength bands. For example, a high-output laser light source can be used for infrared light in a wavelength band of 1.55 micrometers (μm). As a laser light source that emits infrared light in the wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be set and the higher the energy can be set. The light source 271 includes a lens that enlarges the laser light in accordance with a size of a modulation region set in a modulation part 2730 of the spatial light modulator 273. The light source 271 emits light 202 enlarged by the lens. The light 202 emitted from the light source 271 travels toward the modulation part 2730 of the spatial light modulator 273.

The spatial light modulator 273 includes a modulation part 2730. A modulation region is set in the modulation part 2730. In the modulation region of modulation part 2730, a pattern (also referred to as a phase image) corresponding to an image displayed by projection light 205 is set according to the control of the control unit 277. The modulation part 2730 is irradiated with light 202 emitted from the light source 271. The light 202 incident on the modulation part 2730 is modulated according to a pattern (phase image) set in the modulation part 2730. The modulated light 203 modulated by the modulation part 2730 travels toward a reflecting surface 2750 of the curved mirror 275.

For example, the spatial light modulator 273 is achieved by a spatial light modulator using ferroelectric liquid crystal, homogeneous liquid crystal, vertical alignment liquid crystal, or the like. For example, the spatial light modulator 273 can be achieved by liquid crystal on silicon (LCOS). Alternatively, the spatial light modulator 273 may be achieved by a micro electro mechanical system (MEMS). The phase modulation-type spatial light modulator 273 can be operated to sequentially switch the location where the projection light 205 is projected, thereby concentrating energy on an image portion. Therefore, in a case where the phase modulation-type spatial light modulator 273 is used, the image can be displayed brighter than those in the other methods if the output of the light source 271 is the same.

The modulation region of the modulation part 2730 is divided into a plurality of regions (also referred to as tiling). For example, the modulation region of the modulation part 2730 is divided into rectangular regions (also referred to as tiles) set to a desired aspect ratio. A phase image is allocated to each of the plurality of tiles set in the modulation region of the modulation part 2730. Each of the plurality of tiles includes a plurality of pixels. A phase image corresponding to an image to be projected is set to each of the plurality of tiles. The phase images set to the plurality of tiles, respectively, may be the same or different.

A phase image is tiled to each of the plurality of tiles allocated to the modulation region of the modulation part 2730. For example, a phase image generated in advance is set to each of the plurality of tiles. When the modulation part 2730 is irradiated with the light 202 in a state where the phase images are set to the plurality of tiles, modulated light 203 that forms an image corresponding to the phase image of each tile is emitted. A larger number of tiles set in the modulation part 2730 makes it possible to display a clearer image, but a smaller number of pixels of each tile results in a lower resolution. Therefore, the size and number of tiles set in the modulation region of the modulation part 2730 are set according to the application.

The curved mirror 275 is a reflecting mirror having a reflecting surface 2750 having a curved shape. The reflecting surface 2750 of the curved mirror 275 has a curvature corresponding to a projection angle of projection light 205. The reflecting surface 2750 of the curved mirror 275 only needs to include a curved portion. In the example of FIG. 23, the reflecting surface 2750 of the curved mirror 275 has a shape like a side surface of a cylinder. For example, the reflecting surface 2750 of the curved mirror 275 may be a free-form surface or a spherical surface. For example, the reflecting surface 2750 of the curved mirror 275 may have a shape in which a plurality of curved surfaces are combined rather than a single curved surface. For example, the reflecting surface 2750 of the curved mirror 275 may have a shape in which a curved surface and a flat surface are combined.

The curved mirror 275 is disposed with its reflecting surface 2750 facing the modulation part 2730 of the spatial light modulator 273. The curved mirror 275 is disposed on an optical path of the modulated light 203. The reflecting surface 2750 is irradiated with the modulated light 203 modulated by the modulation part 2730. The light (projection light 205) reflected by the reflecting surface 2750 is projected in an enlarged state at an enlargement ratio corresponding to the curvature of the reflecting surface 2750. In the example of FIG. 23, the projection light 205 is enlarged along the horizontal direction (the direction perpendicular to the paper surface of FIG. 23) according to the curvature of the reflecting surface 2750 of the curved mirror 275 in an irradiation range of the modulated light 203. In addition, the projection light 205 is also enlarged in the vertical direction (an up-down direction on the paper surface of FIG. 23) as it becomes far away from the transmission device 27.

For example, a shield (not illustrated) may be disposed between the spatial light modulator 273 and the curved mirror 275. That is, the shield may be disposed on an optical path of the modulated light 203 modulated by the modulation part 2730 of the spatial light modulator 273. The shield is a frame that shields unnecessary light components included in the modulated light 203 and defines an outer edge of a display area of the projection light 205. For example, the shield is an aperture in which a slit-shaped opening is formed in a portion through which light forming a desired image passes. The shield passes light that forms a desired image and shields unnecessary light components. For example, the shields 0th-order light or a ghost image included in the modulated light 203. The details of the shield will not be described.

In the transmission device 27, a projection optical system including a Fourier transform lens, a projection lens, or the like may be provided instead of the curved mirror 275. Alternatively, the transmission device 27 may be configured to directly project the light modulated by the modulation part 2730 of the spatial light modulator 273 without including the curved mirror 275 or the projection optical system.

The control unit 277 controls the light source 271 and the spatial light modulator 273. For example, the control unit 277 is achieved by a microcomputer including a processor and a memory. The control unit 277 sets a phase image corresponding to an image to be projected in the modulation part 2730 in accordance with the aspect ratio of tiling set in the modulation part 2730 of the spatial light modulator 273. For example, the control unit 277 sets, in the modulation part 2730, a phase image corresponding to an image according to the application such as image display, communication, or distance measurement. The phase image of the image to be projected may be stored in advance in a storage unit (not illustrated). The shape and size of the image to be projected are not particularly limited.

The control unit 277 controls the spatial light modulator 273 in such a way as to change a parameter for determining a difference between a phase of the light 202 emitted to the modulation part 2730 of the spatial light modulator 273 and a phase of the modulated light 203 reflected by the modulation part 2730. For example, the parameter is a value related to an optical feature such as a refractive index and an optical path length. For example, the control unit 277 adjusts the refractive index of the modulation part 2730 by changing the voltage applied to the modulation part 2730 of the spatial light modulator 273. The phase distribution of the light 202 emitted to the modulation part 2730 of the phase modulation-type spatial light modulator 273 is modulated according to the optical feature of the modulation part 2730. The method of driving the spatial light modulator 273 by the control unit 277 is determined according to the modulation scheme of the spatial light modulator 273.

The control unit 277 drives the light source 271 in a state where a phase image corresponding to an image to be displayed is set in the modulation part 2730. As a result, the light 202 emitted from the light source 271 is irradiated to the modulation part 2730 of the spatial light modulator 273 in accordance with the timing at which the phase image is set in the modulation part 2730 of the spatial light modulator 273. The light 202 emitted to the modulation part 2730 of the spatial light modulator 273 is modulated by the modulation part 2730 of the spatial light modulator 273. The modulated light 203 modulated by the modulation part 2730 of the spatial light modulator 273 is emitted toward the reflecting surface 2750 of the curved mirror 275.

For example, a projection angle of the projection light 205 is set to 180 degrees by adjusting the curvature of the reflecting surface 2750 of the curved mirror 275 included in the transmission device 27 and the distance between the spatial light modulator 273 and the curved mirror 275. If two transmission devices 27 configured as described above are used, the projection angle of the projection light 205 can be set to 360 degrees. Furthermore, if some of the modulated light 203 is reflected by a plane mirror or the like inside the transmission device 27 to project the projection light 205 in two directions, the projection angle of the projection light 205 can be set to 360 degrees. For example, a transmission device 27 configured to project projection light in the 360-degree direction is combined with a reception device 21 configured to receive a spatial optical signal arriving from the 360-degree direction. With such a configuration, it is possible to achieve a communication device that transmits a spatial optical signal in the 360-degree direction and receives a spatial optical signal arriving from the 360-degree direction.

[Communication Device]

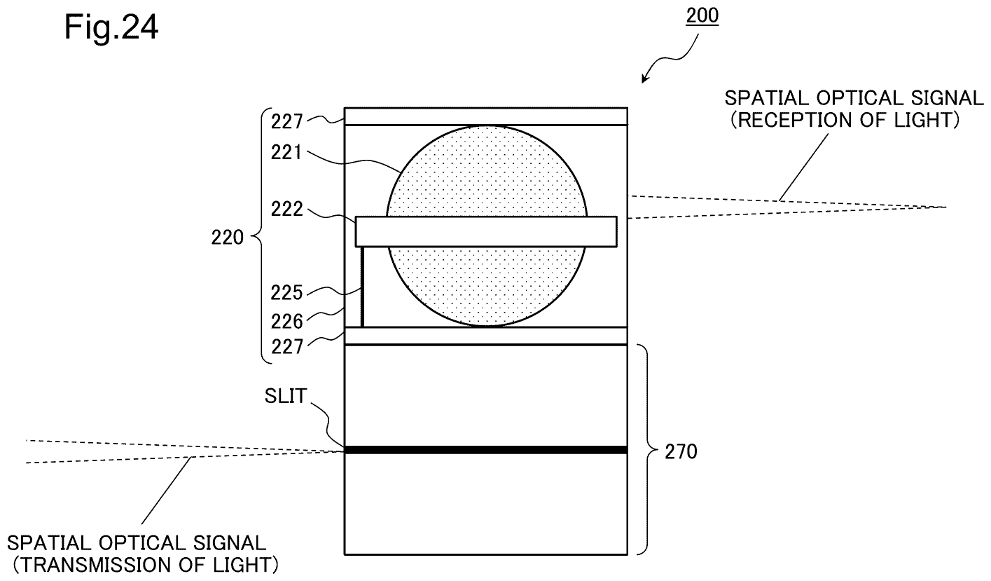

FIG. 24 is a conceptual diagram illustrating an example (communication device 200) of the communication device 20. The communication device 200 includes a receiver 220, a transmitter 270, and a control device (not illustrated). In FIG. 24, the reception circuit and the control device are omitted. The communication device 200 has a configuration in which the receiver 220 having a cylindrical outer shape and the transmitter 270 are combined.

The receiver 220 includes a ball lens 221, a light receiving unit 222, a conductive wire 225, a color filter 226, and a support member 227. The ball lens 221 has the same configuration as the ball lens 11 according to the first example embodiment. The upper and lower portions of the ball lens 221 are sandwiched between a pair of support members 227 arranged vertically. The upper and lower sides of the ball lens 221 may be processed to have a planar shape in such a way as to be easily sandwiched by the support members 227, because they are not used for transmission and reception of spatial optical signals. The light receiving unit 222 is disposed to match a concentrating region of the ball lens 221 in such a way as to be able to receive a spatial optical signal to be received. The light receiving unit 222 has the same configuration as the light receiving unit 12 according to the first example embodiment. The light receiving unit 222 includes a plurality of light receiving elements (not illustrated) and a light guide. The plurality of light receiving elements are connected to the control device (not illustrated) and the transmitter 270 by the conductive wire 225.

The color filter 226 is disposed on a side surface of the cylindrical receiver 220. The color filter 226 removes unnecessary light and selectively transmits a spatial optical signal used for communication. The pair of support members 227 are disposed on upper and lower surfaces of the cylindrical receiver 220. The pair of support members 227 sandwich the ball lens 221 from above and below. The light receiving unit 222 formed in an annular shape is disposed on the emission side of the ball lens 221. A spatial optical signal incident on the ball lens 221 through the color filter 226 is concentrated toward the light receiving unit 222 by the ball lens 221. The optical signal concentrated on the light receiving unit 222 is guided toward the light receiving portion of one of the light receiving elements. The optical signal reaching the light receiving portion of the light receiving element is received by the light receiving element. The control device (not illustrated) causes the transmitter 270 to transmit a spatial optical signal according to the optical signal received by the light receiving element included in the light receiving unit 222.

The transmitter 270 can be achieved by the configuration (transmission device 27) in FIG. 23. The transmitter 270 is housed inside a cylindrical housing. A slit opened to match the direction in which a spatial optical signal is to be transmitted by the transmitter 270 is formed in the cylindrical housing. For example, in a case where the transmitter 270 is capable of transmitting a spatial optical signal in the 360-degree direction, a slit is formed on a side surface of the housing of the transmitter 270 to match the direction in which the spatial optical signal is transmitted.

### Application Example

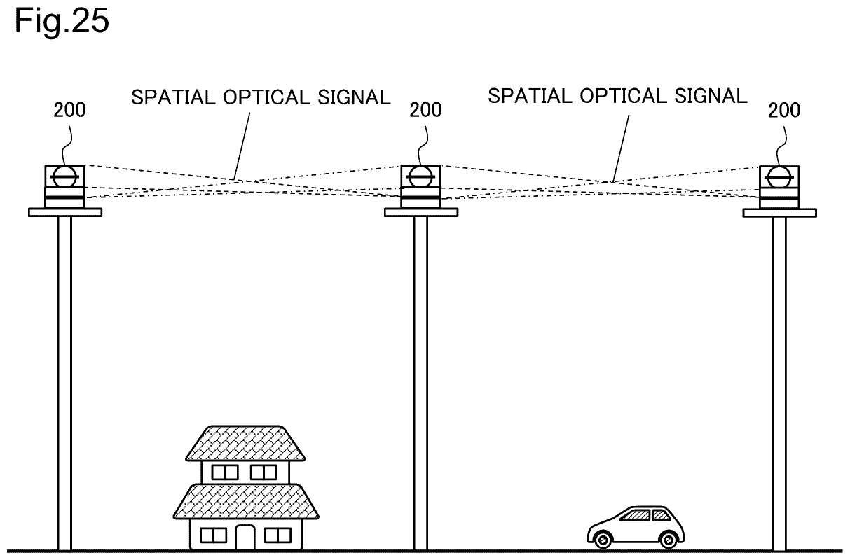

Next, an application example of the communication device 200 according to the present example embodiment will be described with reference to the drawings. FIG. 25 is a conceptual diagram for explaining the present application example. In the present application example, an example of a communication network (also referred to as a communication system) in which a plurality of communication devices 200 are arranged on upper sides of poles such as utility poles or street lamps arranged in a town (also referred to as on-pole spaces) will be described.

There are few obstacles in the on-pole space. Therefore, the on-pole space is suitable for installing the communication device 200. In addition, if the communication devices 200 are installed at the same height, a direction in which spatial optical signals arrives is limited to the horizontal direction. Therefore, the light receiving area of the light receiving unit 222 constituting the receiver 220 can be reduced, thereby simplifying the device. A pair of communication devices 200 that transmit and receive spatial optical signals are arranged in such a way that at least one of the communication devices 200 receives a spatial optical signal transmitted from the other communication device 200. The pair of communication devices 200 may be arranged to transmit and receive spatial optical signals to and from each other. In a case where the communication network for spatial optical signals is constituted by the plurality of communication devices 200, a communication device 200 positioned in the middle may be disposed to relay a spatial optical signal transmitted from another communication device 200 to another communication device 200.

According to the present application example, the plurality of communication devices 200 arranged in the on-pole spaces can communicate with each other using spatial optical signals. For example, according to the communication between the communication devices 200 arranged in the on-pole spaces, a wireless device installed in an automobile, a house, or the like or a base station may communicate with the communication devices 200 in a wireless manner. For example, the communication device 200 may be configured to be connected to the Internet via a communication cable or the like installed on a pole.

As described above, the communication device according to the present example embodiment includes a reception device, a transmission device, and a control device. The reception device includes a ball lens, a light receiving element array, a light guide, and a reception circuit. The ball lens, the light guide, and the light receiving element array constitute a receiver. The light guide and the light receiving element array constitute a light receiving unit. The ball lens is a spherical lens. The light receiving element array includes a plurality of light receiving elements arranged around the ball lens. The light guide includes a plurality of reflection units that guide optical signals concentrated by the ball lens toward the light receiving elements. The reflection unit includes a first reflector and a second reflector. The first reflector is associated with one of the plurality of light receiving elements. The first reflector has a configuration in which reflecting surfaces are formed on inner surfaces tapered from the ball lens toward the light receiving element. The second reflector is disposed inside the first reflector. The second reflector has a configuration in which double-sided mirrors having reflecting surfaces parallel to the reflecting surfaces of the first reflector are combined together. The reception circuit acquires the signal received by the receiver. The reception circuit decodes the acquired signal. The transmission device transmits a spatial optical signal. The control device acquires a signal based on a spatial optical signal from another communication device received by the reception device. The control device executes processing according to the acquired signal. The control device causes the transmission device to transmit a spatial optical signal corresponding to the executed processing.

The communication device according to the present example embodiment includes a reception device that guides optical signals arriving from various directions toward a light receiving element associated with one of the plurality of reflection units constituting the light guide using that reflection unit. The reception device concentrates optical signals arriving from various directions using the ball lens. The optical signals concentrated by the ball lens are efficiently guided by one of the plurality of reflection units constituting the light guide toward the light receiving element associated with the reflection unit. Therefore, the reception device according to the present example embodiment enables communication using spatial optical signals between a plurality of communication devices arranged at various positions.

The communication system according to an aspect of the present example embodiment includes a plurality of communication devices as described above. In the communication system, the plurality of communication devices are arranged to transmit and receive spatial optical signals to and from each other. According to the present aspect, it is possible to achieve a communication network for transmitting and receiving spatial optical signals.

### Third Example Embodiment

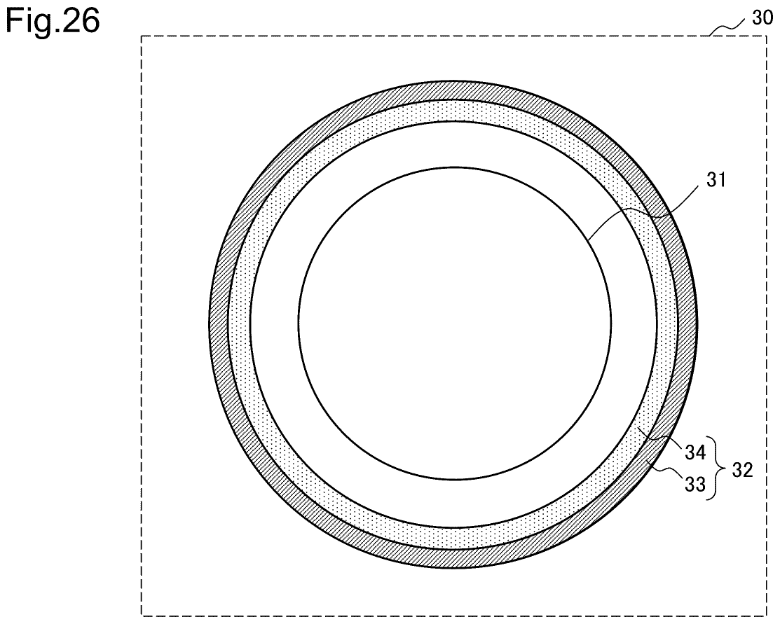

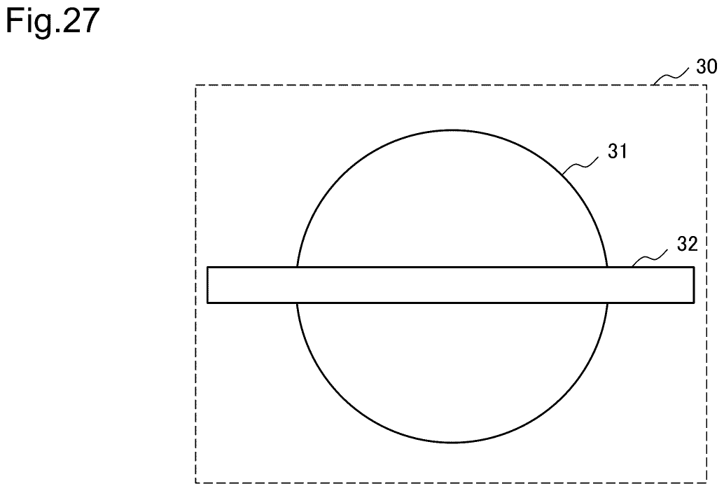

Next, a receiver according to a third example embodiment will be described with reference to the drawings. The receiver according to the present example embodiment has a more simplified configuration than the receiver according to the first example embodiment. FIGS. 26 and 27 are conceptual diagrams illustrating an example of a configuration of the receiver 30 according to the present example embodiment. FIG. 26 is a plan view of the receiver 30 as viewed from above. FIG. 27 is a side view of the receiver 30 as viewed in the lateral direction.

The receiver 30 includes a ball lens 31, a light guide 34, and a light receiving element array 33. The light guide 34 and the light receiving element array 33 constitute a light receiving unit 32.

The ball lens 31 is a spherical lens. The light receiving element array 33 includes a plurality of light receiving elements arranged around the ball lens 31. The light guide 34 includes a plurality of reflection units that guide optical signals concentrated by the ball lens 31 toward the light receiving elements. The reflection unit includes a first reflector and a second reflector. The first reflector is associated with one of the plurality of light receiving elements. The first reflector has a configuration in which reflecting surfaces are formed on inner surfaces tapered from the ball lens toward the light receiving element. The second reflector is disposed inside the first reflector. The second reflector has a configuration in which double-sided mirrors having reflecting surfaces parallel to the reflecting surfaces of the first reflector are combined together.

As described above, the receiver according to the present example embodiment concentrates optical signals arriving from various directions using the ball lens. The optical signals concentrated by the ball lens are efficiently guided by one of the plurality of reflection units constituting the light guide toward the light receiving element associated with the reflection unit. Therefore, the receiver of the present example embodiment can efficiently receive optical signals arriving from various directions.

(Hardware)

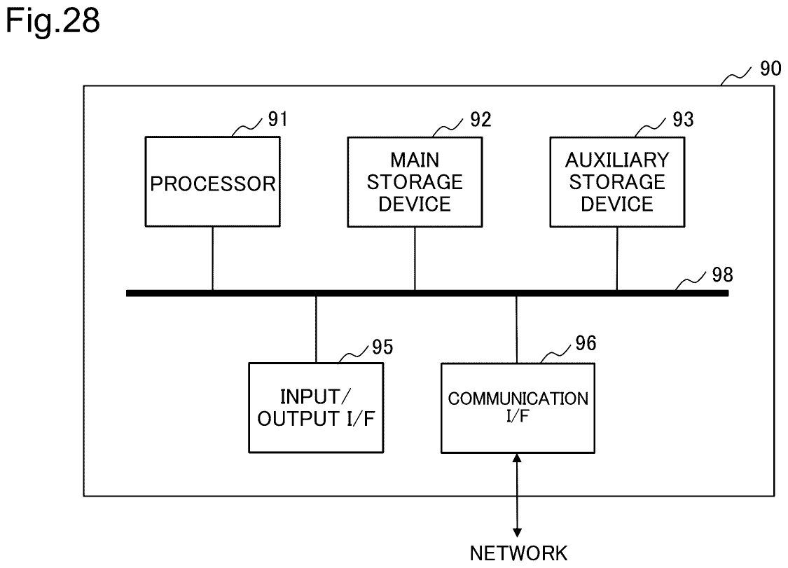

Here, a hardware configuration for executing the control or processing according to each of the above-described example embodiments of the present disclosure will be described using an information processing apparatus 90 illustrated in FIG. 28 as an example. Note that the information processing apparatus 90 of FIG. 28 is an example of the configuration for executing the control or processing according to each of the above-described example embodiments, and does not limit the scope of the present disclosure.

As illustrated in FIG. 28, the information processing apparatus 90 includes a processor 91, a main storage device 92, an auxiliary storage device 93, an input/output interface 95, and a communication interface 96. In FIG. 28, an interface is abbreviated as an I/F. The processor 91, the main storage device 92, the auxiliary storage device 93, the input/output interface 95, and the communication interface 96 are connected to each other via a bus 98 for data communication therebetween. In addition, the processor 91, the main storage device 92, the auxiliary storage device 93, and the input/output interface are connected to a network such as the Internet or an intranet via the communication interface 96.

The processor 91 develops a program stored in the auxiliary storage device 93 or the like in the main storage device 92. The processor 91 executes the program developed in the main storage device 92. In the present example embodiment, a software program installed in the information processing apparatus 90 may be used. The processor 91 executes the control or processing according to each of the above-described example embodiments.

The main storage device 92 has an area in which a program is developed. A program stored in the auxiliary storage device 93 or the like is developed in the main storage device 92 by the processor 91. The main storage device 92 is achieved by a volatile memory such as a dynamic random access memory (DRAM). In addition, a nonvolatile memory such as a magnetoresistive random access memory (MRAM) may be included/added as the main storage device 92.

The auxiliary storage device 93 stores various data such as programs. The auxiliary storage device 93 is achieved by a local disk such as a hard disk or a flash memory. Note that various data may be stored in the main storage device 92, and the auxiliary storage device 93 may be omitted.

The input/output interface 95 is an interface for connecting the information processing apparatus 90 and a peripheral device to each other in accordance with a standard or a specification. The communication interface 96 is an interface for connection to an external system or device through a network such as the Internet or an intranet in accordance with a standard or a specification. The input/output interface 95 and the communication interface 96 may be constituted by a single interface connected to an external device.

An input device such as a keyboard, a mouse, or a touch panel may be connected to the information processing apparatus 90 if necessary. These input devices are used to input information and settings. In a case where the touch panel is used as an input device, a display screen of a display device may also serve as an interface of the input device. Data communication between the processor 91 and the input device may be mediated by the input/output interface 95.

Furthermore, the information processing apparatus 90 may include a display device for displaying information. In a case where the information processing apparatus includes a display device, the information processing apparatus 90 preferably includes a display control device (not illustrated) for controlling the display of the display device. The display device may be connected to the information processing apparatus 90 via the input/output interface 95.

Furthermore, the information processing apparatus 90 may be equipped with a drive device. Between the processor 91 and the recording medium (program recording medium), the drive device mediates reading of data or a program from the recording medium, writing of a processing result of the information processing apparatus 90 to the recording medium, and the like. The drive device only needs to be connected to the information processing apparatus 90 via the input/output interface 95.

An example of the hardware configuration for enabling the control or processing according to each of the above-described example embodiments of the present disclosure has been described above. Note that the hardware configuration of FIG. 28 is an example of the hardware configuration for executing the control or processing according to each of the above-described example embodiments, and does not limit the scope of the present disclosure. In addition, a program for causing a computer to execute the control or processing according to each of the above-described example embodiments also falls within the scope of the present disclosure. Furthermore, a program recording medium recording the program according to each of the above-described example embodiments also falls within the scope of the present disclosure. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium. In a case where a program executed by the processor is recorded in the recording medium, the recording medium is a program recording medium.

The components of the above-described example embodiments may be combined. In addition, the components according to each of the above-described example embodiments may be achieved by software or by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A receiver comprising:
a ball lens;
a light receiving element array including a plurality of light receiving elements arranged around the ball lens; and
a light guide including a plurality of reflection units configured to guide optical signals concentrated by the ball lens toward the light receiving elements, wherein
each of the reflection units includes:
a first reflector associated with one of the plurality of light receiving elements and having reflecting surfaces formed on inner side surfaces tapered from the ball lens toward the light receiving element; and
a second reflector disposed inside the first reflector and formed by combining double-sided mirrors having reflecting surfaces parallel to the reflecting surfaces of the first reflector.

2. The receiver according to claim 1, wherein
the first reflector includes four reflecting surfaces tapered from the ball lens toward the light receiving element, and
the second reflector has a configuration in which four double-sided mirrors each disposed in association with one of the four reflecting surfaces included in the first reflector are combined.

3. The receiver according to claim 2, further comprising
a third reflector disposed inside the second reflector, the third reflector including a double-sided mirror having reflecting surfaces parallel to a straight line connecting the center of the ball lens and the light receiving element to each other.

4. The receiver according to claim 2, further comprising
a fourth reflector disposed inside the second reflector and formed by combining double-sided mirrors having reflecting surfaces parallel to the reflecting surfaces of the second reflector.

5. The receiver according to claim 2, wherein
each of the reflecting surfaces of the first reflector has a portion bent toward a light receiving portion of the light receiving element around the light receiving element.

6. The receiver according to claim 1, wherein
the plurality of reflection units are grouped according to a direction from which spatial optical signals arrive.

7. The receiver according to claim 6, wherein
the light guide has a structure in which the plurality of grouped reflection units are integrated.

8. A reception device comprising:
the receiver according to claim 1; and
a reception circuit configured to acquire a signal received by the receiver and decode the acquired signal.

9. A communication device comprising:
the reception device according to claim 8;
a transmission device configured to transmit a spatial optical signal; and
a control device configured to acquire a signal based on a spatial optical signal from another communication device received by the reception device, execute processing according to the acquired signal, and cause the transmission device to transmit a spatial optical signal according to the executed processing.

10. A communication system comprising:
a plurality of the communication devices according to claim 9, wherein
the plurality of communication devices are arranged to transmit and receive spatial optical signals to and from each other.
